(19) United States
(12) Patent Application Publication
(10) Pub. No.: US 2012/0183116 A1
(43) Pub. Date: Jul. 19, 2012

(54) COMPOSITE NUCLEAR FUEL PELLET

(76) Inventors: Daniel F. Hollenbach, Oak Ridge, TN (US); Larry J. Ott, Knoxville, TN (US); James W. Klett, Knoxville, TN (US); Theodore M. Besmann, Oak Ridge, TN (US); Beth L. Armstrong, Clinton, TN (US)

(21) Appl. No.: 13/387,621

(22) PCT Filed: Jul. 27, 2010
(86) PCT No.: PCT/US10/43307

§ 371 Date: Apr. 3, 2012

Related U.S. Application Data
(60) Provisional application No. 61/230,014, filed on Jul. 30, 2009.

(51) Int. Cl. G21C 3/00; G21C 21/00

(52) U.S. Cl. 376/409; 264/5

(57) ABSTRACT

A composite nuclear fuel pellet comprises a composite body including a UO2 matrix and a plurality of high aspect ratio particies dispersed therein, where the high aspect ratio particies have a thermal conductivity higher than that of the UO2 matrix. A method of making a composite nuclear fuel pellet includes combining UO2 powder with a predetermined amount of high aspect ratio particles to form a combined powder, the high aspect ratio particles having a thermal conductivity higher than that of the UO2 powder; mixing the combined powder in a solvent to disperse the high aspect ratio particles in the UO2 powder; evaporating the solvent to form a dry mixture comprising the high aspect ratio particles dispersed in the UO2 powder; pressing the dry mixture to form a green body; and sintering the green body to form the composite fuel pellet.

### RELATED APPLICATION

The present patent document claims the benefit of the filing date under 35 U.S.C. §119(e) of U.S. Provisional Patent Application Ser. No. 61/230,014, filed Jul. 30, 2009, which is hereby incorporated by reference.

### FEDERALLY SPONSORED RESEARCH AND DEVELOPMENT

This invention was made with government support under Contract No. DE-AC05-00OR22725 awarded by the U.S. Department of Energy. The government has certain rights in the invention.

### TECHNICAL FIELD

The present disclosure is directed generally to uranium oxide nuclear fuel and more particularly to a composite nuclear fuel pellet with enhanced thermal conductivity.

### BACKGROUND

The economical production of electrical energy is recognized as being a vital part of our high standard of living as well as our national defense. The clean, efficient production of energy is necessary for a strong economy. A separate but very much related problem is greenhouse gas production and renewable energy. Coal produces approximately 50% of the electricity in the United States. The production of electricity from coal is economical, and existing known coal reserves should last for about 200 years. However, coal is a finite resource, and it is a major contributor to anthropogenic greenhouse gas production. For these reasons, coal is not seen as a desirable source of additional energy production.

Nuclear power produces no CO₂ or other greenhouse gases, and is thus viewed as environmentally benign. Nuclear reactors are used throughout the United States and the world as a source of energy for the baseline production of electricity. In the United States, 103 nuclear reactors produce ˜20% of the electricity generated in the country. Other countries such as France, Japan, and Korea have larger percentages of their electricity produced by nuclear reactors, with France leading the world, having over 75% of its electricity being produced by nuclear power plants. Worldwide, there are about 440 commercial nuclear power plants in operation with many currently under construction. In the United States, utility companies have applied for over 25 construction/operating licenses (COLS) to build new nuclear generating plants.

There are three main types of commercial nuclear power plants: pressurized water reactors (PWR), boiling water reactors (BWR), and CANDU reactors. PWRs and BWRs use water as the primary coolant to transfer energy from the nuclear fuel. CANDU reactors use heavy water, which is water with a higher proportion of the hydrogen isotope deuterium. Uranium oxide (UO₂) is widely used as fuel for these reactors because it is chemically inert and relatively inexpensive to manufacture.

The commercial nuclear power industry is investing heavily in the development of advanced fuels that can produce higher power levels with a higher safety margin and be produced at low cost. Although chemically stable and inexpensive to manufacture, UO₂ fuel is limited by its low thermal conductivity, which is ˜2.5 W/m·K at 1500° K for fresh fuel and decreases as the fuel is burned, as indicated in FIG. 1. This relationship limits the rate at which heat energy can be removed from the fuel and thus limits the rate of power generation within the fuel. For safe operation, the maximum fuel temperature should not exceed a specified value. The higher the thermal conductivity, the lower the differential between the fuel centerline temperature and edge temperature. If the fuel thermal conductivity could be increased, the energy could more quickly be extracted from the fuel rod, resulting in cooler, more stable fuel and possibly higher total reactor power levels. It would also allow more energy to be extracted from the UO₂ fuel, since degradation of material properties due to high temperatures also limits the total fuel burnup.

Historically, several advanced nuclear fuels, including uranium metal, uranium carbide (UC) and uranium nitride (UN), have been extensively studied, primarily with respect to applications in high-duty fast reactors. Although uranium metal has been successfully used in fast reactors with liquid sodium as a coolant, it is unsuitable for use in water reactors since uranium metal reacts strongly with water. UC and UN both have very high thermal conductivities (>20 W/m·K, which increases with increasing temperature and does not decrease as the fuel is burned). Both of these types of fuels are more expensive to make, are chemically more reactive, and can react with water at operating temperatures. Even given these limitations, both UC and UN are being examined as possible replacements for UO₂ as the primary fuel in water-cooled reactors because of their high thermal conductivities and mechanical stability as the fuel is burned.

### BRIEF SUMMARY

A composite nuclear fuel pellet that may have advantages over existing UO₂ fuel is described, and a method of making a composite nuclear fuel pellet is also disclosed. The composite nuclear fuel pellet comprises a composite body including a UO₂ matrix and a plurality of high aspect ratio particles dispersed therein, where the high aspect ratio particles have a higher thermal conductivity than that of the UO₂ matrix.

The method of making a composite nuclear fuel pellet entails combining UO₂ powder with a predetermined amount of high aspect ratio particles to form a combined powder, the high aspect ratio particles having a thermal conductivity higher than that of the UO₂ powder; mixing the combined powder in a solvent to disperse the high aspect ratio particles in the UO₂ powder; evaporating the solvent to form a dry mixture comprising the high aspect ratio particles dispersed in the UO₂ powder; pressing the dry mixture to form a green body; and sintering the green body to form the composite fuel pellet. Advantageously, the high aspect ratio particles are homogeneously dispersed in the uranium oxide powder.

### BRIEF DESCRIPTION OF THE DRAWINGS

FIG. 1 shows thermal conductivity as a function of temperature (K) for UO₂ fuel at different burnups of gigawatt-days per metric ton of uranium (GWd/MT);

FIG. 2 is a schematic showing an ABA stacking sequence for highly ordered graphite;

FIG. 3 includes optical micrographs of PocoFoam™ (graphite foam developed at Oak Ridge National Laboratory);

FIG. 4 is a schematic of a composite fuel pellet according to one embodiment;

FIG. 5 is a cross-sectional schematic of a high aspect ratio particle including a surface coating;

FIGS. 6a-6b are schematics of a composite fuel pellet according to two embodiments;

FIGS. 7a-7b show fission densities for UO₂ with two volume percent graphite in a heterogeneous mixture with 10 micron fiber diameter and in a homogeneous mixture;

FIGS. 8a-8c show flux densities for UO₂ with two volume percent graphite in a heterogeneous mixture with 10 micron fiber diameter and in a homogeneous mixture;

FIGS. 9a-9l show, at various graphite volume percentages, K_{eff} as 5% and 10% enriched UO₂ is depleting;

FIGS. 10a-10l show, at various graphite volume percentages, metric ton of U-235 per metric ton of uranium during the depletion of five and ten percent enriched UO₂ fuel;

FIGS. 11a-11l show, at various graphite volume percentages, metric ton of U-238 per metric ton of uranium during depletion of five and ten percent enriched UO₂ fuel;

FIGS. 12a-12l show, at various graphite volume percentages, metric ton of Pu-239 per metric ton of uranium during depletion of five and ten percent enriched UO₂ fuel;

FIG. 13 shows thermal conductivity vs. graphite fiber volume percent for idealized UO₂/graphite composite fuel pellets;

FIG. 14 shows temperature as a function of radius (distance from centerline) for UO₂ fuel pellets of various thermal conductivities;

FIG. 15 shows fission gas cumulative fraction release for varying thermal conductivities of UO₂ fuel pellets; and

FIG. 16 is a scanning electron microscopy (SEM) image of a carbon fiber including a SiC barrier layer.

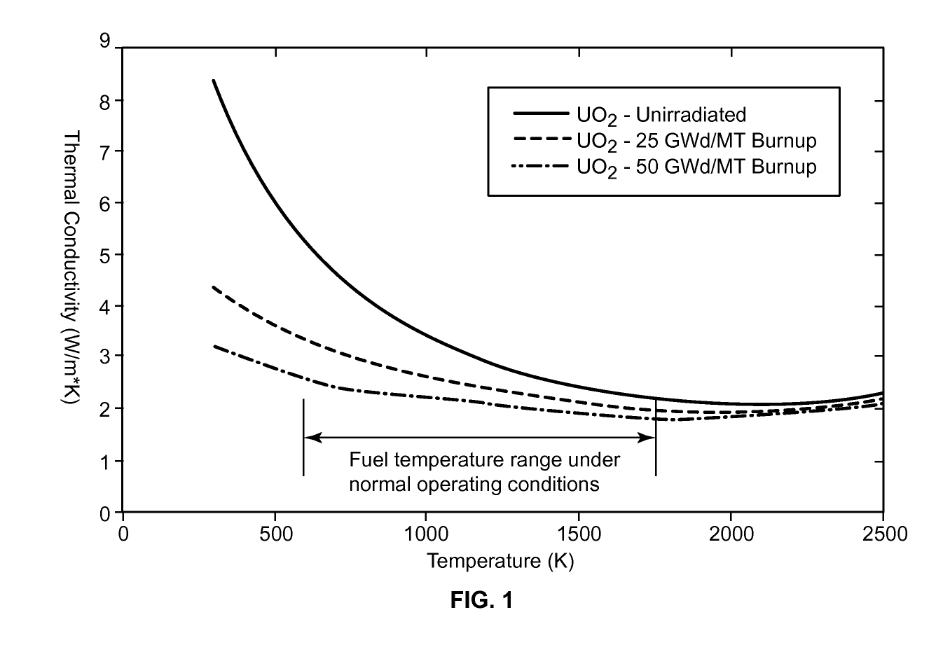

### DETAILED DESCRIPTION

Computer simulations suggest that the thermal conductivity of UO₂ nuclear fuel may be increased by adding high aspect ratio fibers of a thermally conductive material, such as graphitic carbon, to the UO₂ fuel during the manufacturing process. At reactor operating temperatures, UO₂ has a very low thermal conductivity (<5 W/m·K), which decreases with increasing fuel burnup. This low thermal conductivity limits the rate at which energy can be removed from the fuel, thus limiting the total integrated reactor power. An increase in the thermal conductivity of the fuel may result in a cooler fuel that experiences significantly less damage, thus allowing higher burn-up ratios. Nuclear reactors may also be able to operate at higher power levels (in some plants, in excess of 10% higher) thus decreasing the overall cost of electricity and the number of new electrical generating plants needed to meet demand. Also, higher U-235 enrichments (current U-235 enrichment of nuclear fuel is limited to 5 wt. %) may allow the fuel to burn longer, resulting in fewer refueling outages and less spent-fuel per megawatt electric generation.

In addition to having a higher thermal conductivity, the material added to the UO₂ preferably is chemically inert, so it does not react with the UO₂ or water. It is also desirable to use a material with a low neutron absorption cross-section. Preferably, the neutron absorption cross-section of the material added to the UO₂ is at least an order of magnitude lower than that of the UO₂, and it may be two or more orders of magnitude lower. Ideally, the neutron absorption cross-section is near zero.

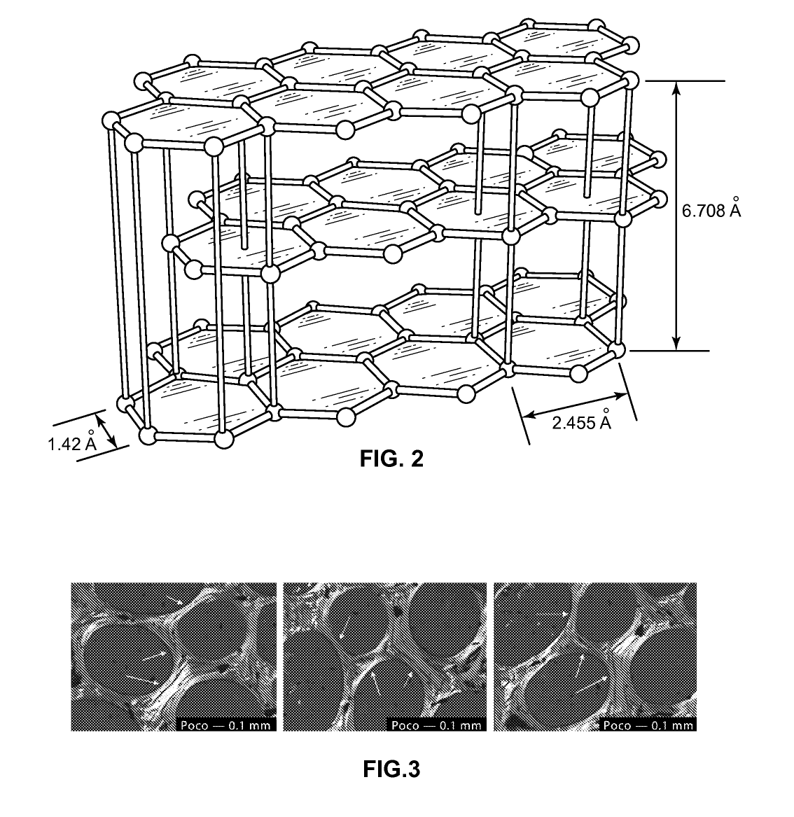

Carbon, particularly highly ordered (crystalline) graphite, which is shown schematically in FIG. 2, is believed to be particularly advantageous for adding to the UO₂ in the form of high aspect ratio fibers that have a length-to-width ratio (aspect ratio) of at least about 100. Typically, the aspect ratio is from about 100 to about 500. The aspect ratio may also be from about 200 to about 400. Amorphous graphite has a thermal conductivity of about 10 W/m·K. However, the theoretical thermal conductivity of crystalline graphite is about 2000 W/m·K at room temperature along crystallographic basal planes, and about 10 W/m·K perpendicular to the basal planes. Another carbon structure, carbon foam, which was originally developed at Oak Ridge National Laboratory, has a structure composed of highly ordered basal planes as ligatures connected by graphite nodes, as shown in FIG. 3. Carbon foam is described in U.S. Pat. No. 6,033,506, “Process for Making Carbon Foam,” which issued on Mar. 7, 2000 and is hereby incorporated by reference. Advanced versions of this foam have a thermal conductivity of ˜180 W/m·K in one dimension and ˜60 W/m·K in the transverse dimensions. Carbon nanotubes, which are essentially rolled sheets of graphene, have been shown to have a thermal conductivity of over 200 W/m·K for bulk samples of single walled tubes and over 3000 W/m·K for individual multiwalled nanotubes (J. Hone, “Carbon Nanotubes: Thermal Properties,” Dekker Encyclopedia of Nanoscience and Nanotechnology, Marcel Dekker, Inc. New York, N.Y. 2004 (603-610)). Unirradiated silicon carbide has a thermal conductivity of 120 W/m·K.

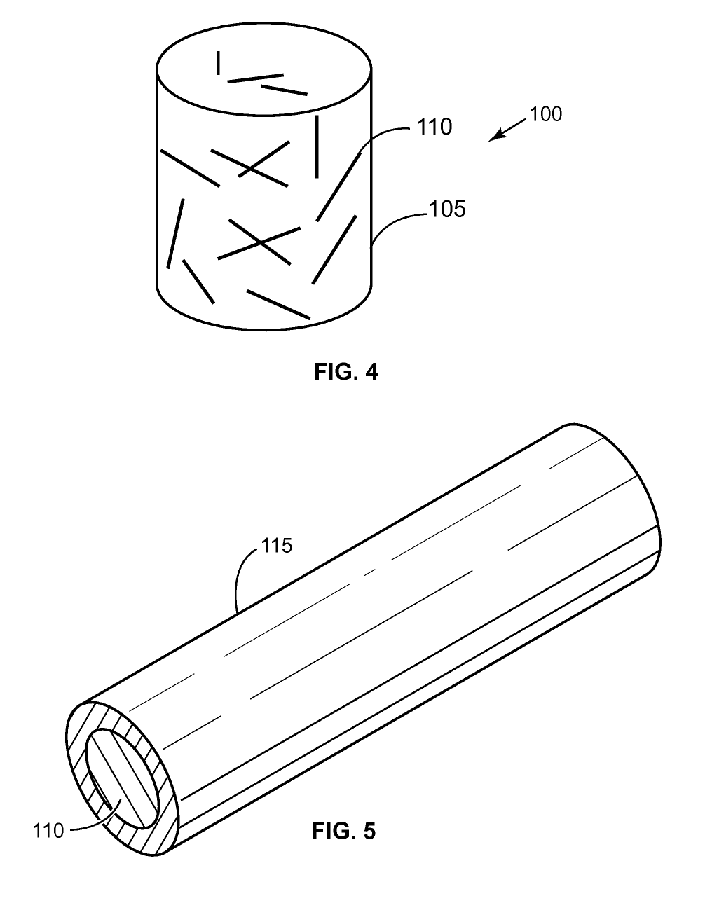

FIG. 4 shows a schematic of a composite pellet of UO₂ fuel. The composite pellet 100 includes a UO₂ matrix 105 and a plurality of high aspect ratio particles 110 dispersed therein, the high aspect ratio particles 110 comprising a material having a thermal conductivity higher than that of the UO₂ matrix 105. It is also preferred that the material of the high aspect ratio particles have a low neutron absorption cross-section.

The material of the high aspect ratio particles may include carbon, such as highly ordered graphite, where carbon atoms are arranged in a regular hexagonal lattice. Graphitic carbon is preferred in order to maximize the thermal conductivity of the composite fuel. For example, the high aspect ratio particles may include carbon fibers, carbon foam, and/or carbon nanotubes (single-wall or multi-wall nanotubes). It is also envisioned that the material of the high aspect ratio particles may include a non-carbon material that has a thermal conductivity higher than that of the UO₂ matrix, such as aluminum nitride (AlN), which has a thermal conductivity of 285 W/mK and a melting temperature of 2200° C. Silicon carbide may also be suitable.

The high aspect ratio particles may be individually dispersed throughout the UO₂ matrix, or the particles may be dispersed in bundles or other aggregates. For example, if the high aspect ratio particles comprise carbon nanotubes, bundles including a plurality of the carbon nanotubes may be dispersed throughout the UO₂ matrix. High aspect ratio particles that contain highly ordered graphite and are dispersed in UO₂ fuel pellets can act as heat conduits for transferring energy generated deep inside the pellet to the outer edge.

Referring to FIG. 5, the high aspect ratio particles 110 may include a surface coating or modified surface 115 to inhibit chemical interactions between the particles and the matrix during fabrication (e.g., during sintering). A steady state analysis suggests that if UO₂ powder and carbon (non-graphitic) are mixed together and heated in an open system, UC and CO₂ may be continuously formed until either the UO₂ or the carbon is consumed. However, the present system may differ from that considered in the analysis in that UO₂ and the high aspect ratio particles may not be continuously mixed, and graphitic carbon may be employed instead of non-graphitic carbon. Furthermore, a fuel pin is expected to behave differently from an open system. In a reactor, the UO₂ fuel is sealed in a fuel pin with several atmospheres of helium overpressure. Green (unsintered) UO₂ pellets are typically sintered in a slightly reducing atmosphere (e.g., argon/4-6% H₂), yielding a sintered pellet having on average 1.98 oxygen atoms per uranium atom. This same processing approach may be applied to the composite pellets, and thus may help to limit or prevent interaction between the graphite and UO₂. Also, the anticipated increase in thermal conductivity of the fuel may reduce the interaction between the graphite and UO₂.

Another possible way to minimize the interaction of UO₂ with carbon-based high aspect ratio particles is by coating or modifying the surface of the high aspect ratio particle to include a thin layer of a barrier material, such as a carbide. For example, SiC or B₄C may be suitable materials to form a surface coating. This can be accomplished, in the case of SiC, by passing a silicon-containing gas (e.g., silane gas) over the carbon fibers in a reaction chamber. By controlling the time and temperature of the reaction, the desired thickness of the SiC layer can be formed.

For example, commercially available pitch based carbon fibers (Amoco P-55S) may undergo a two-step process to form a SiC layer on the surface of the fibers. First, chemical vapor deposition (CVD) is employed to coat the surfaces of the fibers with silicon using silane gas (argon-5% SiH₄) as the precursor. Following the silicon deposition, the coated fibers are heat treated at sufficiently high temperatures under an inert gas, such as argon, thereby causing the silicon and carbon to react and converting the surface of the fibers into a SiC coating. The thickness of the surface coating 115 is preferably about 1% of the diameter of the fiber or less. In general, the coating may range from about 0.1% to about 5% of the diameter of the fiber. Graphite fibers including an exemplary SiC coating of about 0.5 micron in thickness are shown in FIG. 16. The intent is to make the fiber coating thick enough to prevent interaction between the graphite and UO₂ but thin enough so that it does not reduce the overall thermal conductivity of the system. This SiC layer may thus act as a protective barrier between the UO₂ and graphite.

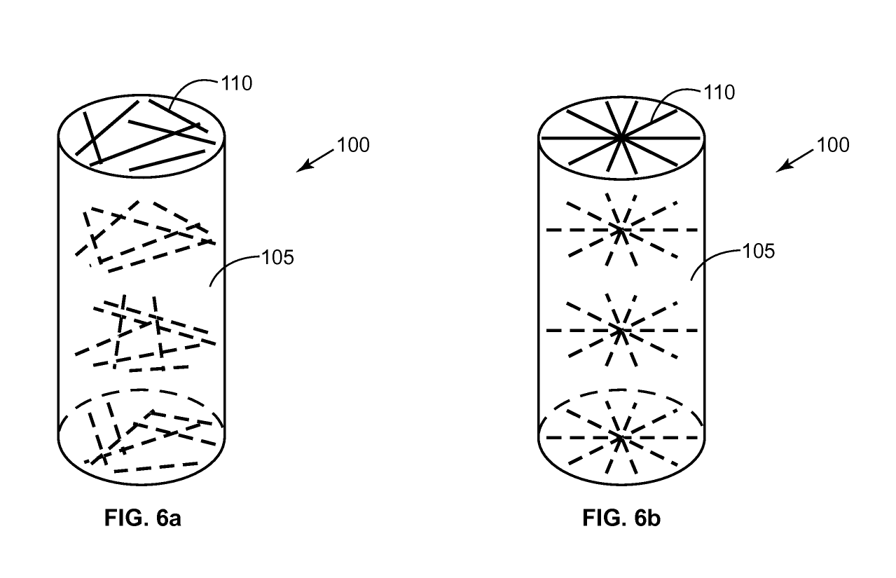

A small volume fraction of particles may be sufficient to provide the desired thermal conductivity of the nuclear fuel pellet. Preferably, the composite pellet includes about 5 vol. % or less of the high aspect ratio particles. For example, the composite pellet may include from about 1 vol. % to about 3 vol. % of the high aspect ratio particles. To facilitate the function of the high aspect ratio particles as heat conduits that may efficiently transfer the energy generated deep inside the pellet to the outer edge, it is desirable that the high aspect ratio particles have a length-to-width ratio ranging from about 100 to about 500. The high aspect ratio particles may be randomly oriented in the composite pellet. Alternatively, it may be advantageous for the particles to be radially oriented within the pellet, assuming the composite fuel pellet has a generally cylindrical shape. A radial orientation of at least a portion, or substantially all, of the high aspect ratio particles 110 within the oxide matrix 105, may improve their capacity to remove heat from the centerline of the fuel pellet 100. In the radial orientation, as shown schematically according to one embodiment in FIG. 6a, the long axis of some or all of the high aspect ratio particles 110 may be aligned parallel or nearly parallel to an end or base of the pellet 100, such that the long axis is directed toward the curved side of the pellet 100. This radial orientation of the high aspect ratio particles 110 may extend uniformly through the thickness (length) of the pellet. Some or all of the high aspect ratio particles 110 may also extend from or pass through the centerline of the pellet 100 in the radial orientation (“true radial orientation”), as shown schematically in FIG. 6b.

It may also be advantageous for the high aspect ratio particles to have a length ranging from about 50% to about 100% of the radius of the composite pellet, particularly if the particles are radially oriented within the fuel pellet. Typically, nuclear fuel pellets range in diameter from about 0.5 cm to about 1.25 cm with a thickness between about 3 mm and about 12 mm. Accordingly, the high aspect ratio particles may range in length from about 0.25 cm (2.5 mm) to about 1.25 cm (12.5 mm), although shorter lengths may also be advantageous. For example, the high aspect ratio particles may have a length in the range of from about 1 mm to about 6 mm, and they may have a thickness or width (or diameter if the particles have a circular transverse cross-section) ranging from a few nanometers to tens of microns. For example, the high aspect ratio particles may be from 5 microns to 15 microns in diameter. The high aspect ratio particles are preferably thick enough to withstand the compaction forces during processing. Accordingly, high aspect ratio particles of nanoscale diameters or thicknesses, such as carbon nanotubes, may be present in the UO₂ matrix in the form of bundles, cables, or other aggregates, as mentioned above. The bundles of these nanoscale particles may fall within the above-mentioned ranges of lengths and thicknesses.

With the described configuration, the composite fuel pellet may boast a substantially improved thermal conductivity compared to conventional UO₂ fuel pellets. The thermal conductivity of the composite pellet may be at least double and preferably triple the thermal conductivity of a standard UO₂ pellet, which varies with temperature range and burnup. In some cases, for example, the thermal conductivity of the composite pellet may be at least about 6 W/m·K, or at least about 9 W/m·K at reactor operating temperatures.

To fabricate a composite fuel pellet having the desired properties, a predetermined amount of high aspect ratio particles (e.g., carbon fibers) is mixed with uranium oxide powder. In an exemplary mixing process using cerium oxide (ceria) as a surrogate for the radioactive uranium oxide powder, ceria powder and graphite fibers (Amoco P-55S) are blended at a slow speed in a ceramic ball mill commercially available from U.S. Stoneware (Palestine, Ohio). Ceria is used for the proof of concept experiments as it has similar physical and mechanical properties to uranium oxide powder. Ideally, the fibers are gently mixed with the oxide powder to avoid fracturing the fibers. The mixing typically takes place over several hours (e.g., from about 0.5-24 h) using a small number of ceramic balls in a cylindrical Nalgene container.

The fibers and oxide powder may be mixed in an aqueous or organic solvent along with a suitable dispersant to minimize or prevent aggregation of the fibers. Due to the high surface area of the fibers, fairly substantial amounts of dispersant may be added to the mixture to promote good dispersion of the fibers; for example, a dispersant concentration of about 1% by weight of the powder or greater may be used. The fibers are preferably homogeneously dispersed throughout the oxide matrix during the mixing process.

The organic solvent may be selected from ethanol, isopropyl alcohol, methanol, acetone and combinations thereof; suitable organic dispersants that are soluble in such organic solvents may include polyvinylpyrrolidone, amines (e.g., polyamine), polyethylene glycol (PEG), phenols, polyesters, polyvinyl butyral resin, oxazoline compounds, ethoxylated alkylguanidine amine complexes, myristate, palmitate, and glyceryl mono/dioleate, and combinations thereof.

The aqueous solvent may be water, deionized water, distilled water or combinations thereof; suitable organic dispersants that are soluble in such aqueous solvents may include latex/acrylic and families thereof, such as acrylic acid, polyacrylic acid, polyacrylate, and methylacrylate; polyethyleneimine (PEI), polyethylene oxide (PEO), PEO/PEI comb polymers, polyvinyl alcohol (PVA), polysaccharides (e.g., alginates, xanthan gum, guar gum, carrageenan, gum arabic, gellan gum cellulose and families thereof such methycellulose), polyvinylpyrrolidone, phosphates, stearic acids, and stearates, sulfonic acids and sulfonates, polyesters, sulfosuccinic acid and its derivatives, sulfonic acids, and phosphate esters and combinations thereof.

During the mixing process, some or all of the fibers may be radially oriented such that the long axis of each fiber is parallel (or nearly parallel) to the base of the container. In other words, the fibers may be perpendicular (or nearly perpendicular) to the centerline or longitudinal axis of the container. In this configuration, the fibers are directed towards the cylindrical side of the container. The fibers may also pass through the centerline of the container so as to have a true radial orientation.

Once the fibers are satisfactorily oriented and/or homogeneously dispersed within the oxide powder, the mixture is dried by evaporating the solvent. Sintering operations that are currently employed to form conventional UO₂ pellets may be used to compact and densify the dried mixture to form a composite fuel pellet (e.g., see A Guide to Nuclear Power Technology, Frank J. Rahn et al., John Wiley & Sons (1984) 236-241, which is hereby incorporated by reference). For example, after the high aspect ratio particles (e.g., graphitic fibers or carbon nanotubes) are mixed with UO₂ powder, the mixture may be compacted in air using conventional pressing techniques. The resulting green UO₂/carbon pellets may be sintered in a slightly reducing atmosphere (e.g., argon/4-6% H₂) to scavenge oxygen and attain a high density (e.g., about 95% or higher) composite pellet containing the desired volume fraction of the high aspect ratio particles.

### Computer Analysis of UO₂/Graphite Composite Fuel

Preliminary computer studies show that a substantial increase in the bulk thermal conductivity of a material is possible through the addition of long thin threads or fibers of a thermally conductive material. The computer analysis of the UO₂/graphite composite fuel is divided into three parts: (A) neutron characteristics of graphite in UO₂; (B) burn-up characteristics of UO₂/graphite fuel; and (C) physical characteristics of UO₂/graphite in a reactor.

### Neutron Characteristics of Graphite in UO₂

To analyze the neutron characteristics of graphite in a UO₂/graphite composite fuel pellet, heterogeneous and homogeneous mixtures of various volume percents and configurations of graphite in UO₂ are compared. Similar heterogeneous and homogeneous mixtures of UO₂ fuel with graphite may be found by comparing the keff and energy of average lethargy of fission values (EALF) for both mixtures. Once the similar mixtures are found, fission densities and flux densities may be compared to determine the neutron similarities of the UO₂ fuel with graphite homogeneous and heterogeneous mixtures.

The presence of graphite fibers in UO₂ fuel pellets, which are then surrounded by cladding and placed in a regular array with interstitial water, presents a double heterogeneous problem. The double heterogeneous system in this case is composed of a heterogeneous mixture of graphite fibers in UO₂ forming a composite which is in a regular array with interstitial water. This can readily be handled using continuous energy cross-section data, which are usable by the criticality codes available in the SCALE Code Package. However, the TRITON nuclear fuel depletion sequence, also part of the SCALE Code Package, does not use continuous energy cross-section data. TRITON uses group cross-section data that is then processed using CENTRM/PMC to properly account for self-shielding, array effects, interstitial moderators, and other factors. The current versions of the CENTRM/PMC codes do not have the capability to properly process the type of double heterogeneity encountered in this type of fuel. Accordingly, a different technique has been developed to ensure that the effects of graphite fibers may be properly accounted for in the uranium contained in the fuel.

To develop a method to account for the double heterogeneity effect of graphite fibers in UO₂ fuel, simulated experiments are created using the CSAS26 sequence. Two different sets of input problems are created, one that includes heterogeneous mixtures of a regular array of graphite fibers in UO₂, and another that includes homogeneous mixtures of graphite and UO₂. A homogeneous mixture contains two or more materials thoroughly mixed such that, even in small amounts, they retain bulk material properties. A heterogeneous mixture also contains two or more materials that, although mixed together, still retain their macroscopic properties. These two sets of problems are used to compare the effects of homogeneously mixing the carbon graphite into the UO₂ and heterogeneously mixing the graphite into UO₂ by having the long thin fibers aligned in an array in the fuel pellets of UO₂ fuel. In both sets, different cases are created by varying the percent of graphite in the UO₂ fuel, ranging from zero to five volume percent carbon graphite, and by varying the diameter and spacing of the graphite fibers. The relevant information derived from these sets of data includes but is not limited to values for keff, EALF, UO₂ and graphite flux and fission density values. The homogeneous and heterogeneous mixtures are compared by finding similar values for keff and EALF.

Using continuous energy cross-sections, the CSAS26 program is used to analyze both the homogeneous and heterogeneous sets of cases. To determine similarities between heterogeneous and homogeneous cases, the keff and EALF values of each heterogeneous case are compared to the range of homogeneous cases. Once two similar homogeneous and heterogeneous mixtures are found based on the keff and EALF values, the fission density and flux densities are then graphed to compare the neutronic properties of the homogeneous and heterogeneous mixtures.

The results show that homogeneous and heterogeneous mixtures with the same graphite volume percent have the closest keff and EALF values. In the heterogeneous cases where the fiber diameter varies, the keff value increases with increasing graphite volume percent in the UO₂ fuel. For the homogeneous cases, the value of keff also increases with increasing graphite volume percent in the UO₂ fuel. As the fiber diameter increases for the heterogeneous mixtures, the EALF remains relatively the same as the homogeneous mixture with the same graphite volume percent. Over the range of fiber diameters from 5×10⁻⁴ to 5×10⁻² cm, the fiber diameter of the graphite has no effect on the keff or EALF value when compared to similar volume percent graphite whether homogeneously mixed or at different graphite fiber diameter. Table 1 below shows EALF and keff values at varying graphite volume percent for the homogeneous mixtures and the heterogeneous mixtures with 10 micron, 50 micron, and 100 micron diameter fibers.

TABLE 1

| | Homogeneous | | Heterogeneous | | Heterogeneous | | Heterogeneous | |
|---|---|---|---|---|---|---|---|---|
| | Mixture | | (10 μdiameter) | | (50 μdiameter) | | (100 μdiameter) | |
| Graphite | Keff | EALF | Keff | EALF | Keff | EALF | Keff | EALF |
| Volume % | (sigma) | (sigma) | (sigma) | (sigma) | (sigma) | (sigma) | (sigma) | (sigma) |
| 1 | 1.43044 | 0.677748 | 1.43052 | 0.677553 | 1.43043 | 0.677973 | 1.43018 | 0.676773 |
| | (0.0002) | (0.00062) | (0.00019) | (0.00062) | (0.00019) | (0.00062) | (0.00021) | (0.00062) |
| 2 | 1.43086 | 0.663817 | 1.43063 | 0.663645 | 1.43121 | 0.664372 | 1.43135 | 0.663889 |
| | (0.00021) | (0.00060) | (0.0002) | (0.00060) | (0.00019) | (0.00060) | (0.00019) | (0.00059) |
| 3 | 1.43193 | 0.649453 | 1.43213 | 0.650702 | 1.43184 | 0.649611 | 1.43201 | 0.649811 |
| | (0.00018) | (0.00058) | (0.00019) | (0.00057) | (0.00019) | (0.00058) | (0.00019) | (0.00059) |
| 4 | 1.43272 | 0.636664 | 1.43278 | 0.636029 | 1.43283 | 0.635211 | 1.43247 | 0.6371 |
| | (0.0002) | (0.00056) | (0.00019) | (0.00057) | (0.00019) | (0.00057) | (0.00019) | (0.00057) |
| 5 | 1.43338 | 0.622992 | 1.43347 | 0.623663 | 1.43341 | 0.623127 | 1.43337 | 0.622838 |
| | (0.0002) | (0.00057) | (0.00019) | (0.00057) | (0.0002) | (0.00055) | (0.0002) | (0.00057) |

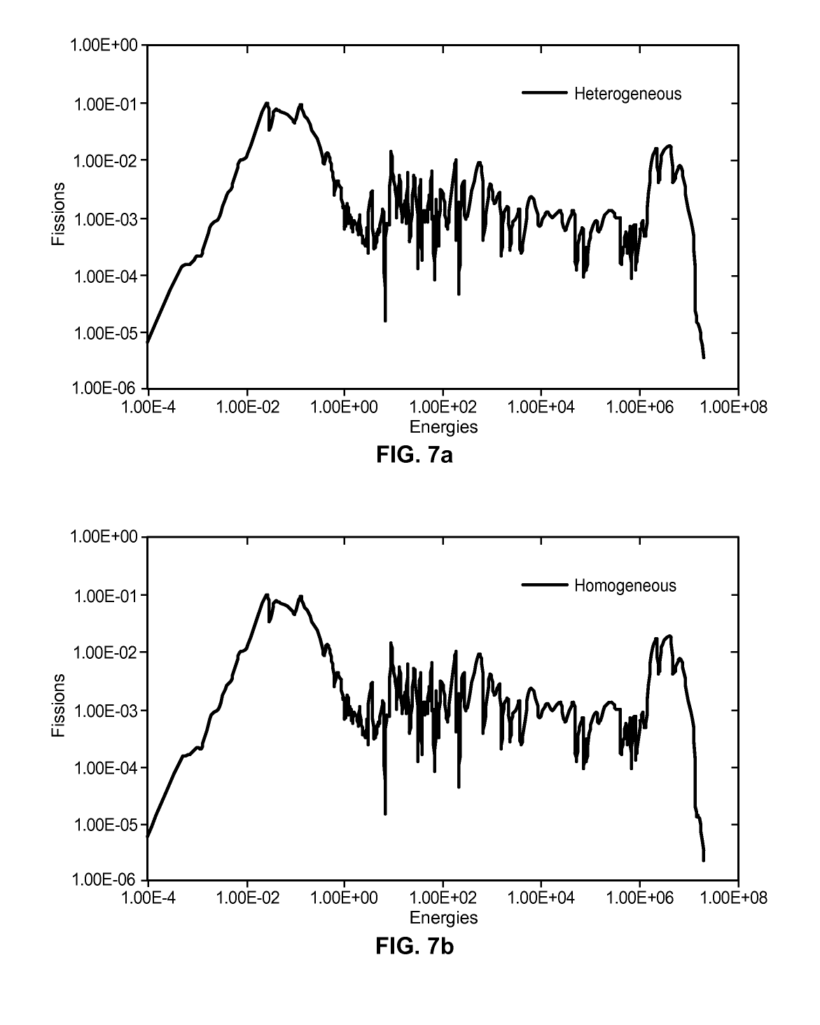

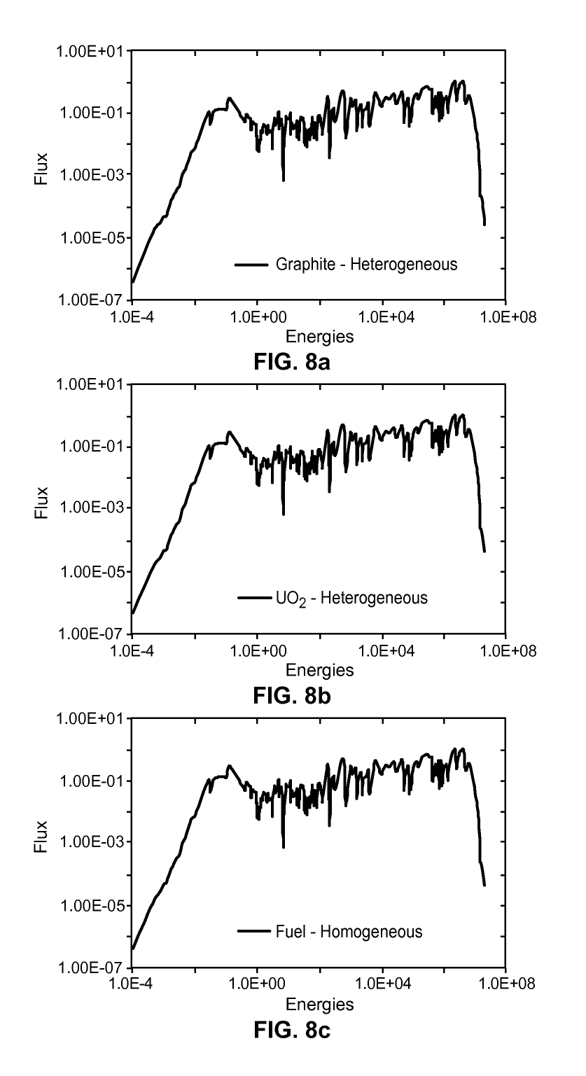

A comparison of the flux densities and fission densities between the homogeneous and heterogeneous cases confirms the keff and EALF data. The best match is consistently between cases having the same graphite volume percent. This can be understood given the very low graphite absorption and scattering cross section relative to the uranium cross section. In FIGS. 7a-7b, the fission density of the homogeneous mixture with two volume percent graphite in the UO₂ fuel is compared to the heterogeneous mixture with two volume percent graphite and a 10 micron fiber diameter. In FIGS. 8a-8c, the flux density of the homogeneous mixture with two volume percent graphite in the UO₂ fuel is compared to the heterogeneous mixture with two volume percent graphite and a 10 micron fiber diameter. Both figures show substantially the same neutron characteristics between the homogeneous cases and the heterogeneous cases at the same volume percent of graphite.

### Burn-Up Characteristics of UO₂/Graphite Composite Fuel

The burn-up characteristics of the UO₂/graphite mixture are investigated by burning both five percent and ten weight percent enriched fuel containing graphite varying from zero to five volume percent. Using this information, it is possible to determine the effects of graphite on the expected amount of energy the fuel can produce and to better understand the increase in energy production as a function of U-235 enrichment as well as the fission product and actinide inventory. By increasing the uranium-235 fuel enrichment, the maximum burn-up can be increased, resulting in more energy per fuel bundle. In the analysis, the fuel is considered to be completely burned when the keff of the system reaches 1.0. This provides information about the maximum burn-up as a function of initial U-235 enrichment. During burn-up, the selected isotopic inventories are compared to examine the effects of the presence of graphite and increased U-235 enrichment. These selected isotopes include U-235 and U-238 as the primary uranium fuel isotopes and Pu-239 and Pu-240 as representative actinides.

The computer program TRITION is used to simulate the depletion of uranium in the fuel and the generation of fission products as a function of power and days burned. Two sets of cases are created to model the depletion; one set contains five percent enriched UO₂ fuel, while the other set contains ten percent enriched UO₂ fuel. To see the effect of adding graphite to the mixtures, both sets cover six different cases, which differ by the percentage of graphite in the UO₂ fuel (from zero to five volume percent). Based on the previous results regarding the configuration of the graphite in the fuel, the graphite/UO₂ fuel is created as a homogeneous mixture.

Increasing the amount of U-235 in the UO₂ fuel allows more energy per fuel bundle to be generated from the nuclear reactors and thus less spent fuel per megawatt-day of generated energy. Generating data for both five percent-enriched UO₂ fuel and ten percent-enriched UO₂ fuel allows one to see the effect of increasing U-235 content in the fuel on the length of time and maximum energy available as a function of U-235 weight percent. It is assumed that the fuel is spent, i.e., that no more energy can be extracted, when the keff has dropped to a value of 1.0. This provides a means of comparing all cases using a common parameter, that is, the fuel's ability to maintain a self-sustained chain reaction.

The burn-up characteristics of the fuel are evaluated as a function of graphite content and uranium enrichment. Multiple parameters are used to compare the effects of graphite on the fuel. Although the uranium content decreases as the graphite volume increases for a given fuel bundle design, the higher thermal conductivity of the composite fuel may permit larger diameter fuel pellets. Therefore, the analyses are done on a per metric ton of uranium basis. How the graphite affects the total amount of energy that can be extracted per metric ton of uranium is investigated. The graphite softens the neutron spectrum, thus affecting the actinide and fission product production, which also affects the overall criticality of the system.

In addition to the fuel characteristics, the TRITON input includes the reactor power as a function of MW/MTU (megawatts per metric ton uranium), the total time burned, and the burn-up step time. Cases containing five percent-enriched fuel and ten percent-enriched fuel are created for zero to five volume percent graphite in the fuel at 1 volume percent increments. Each case is run for 1500 days at a power of 60 MW/MTU. A time step of 10 days is used to produce a fine distribution of system keffs, actinide content, and fission product content for comparison. TRITON assumes an infinite system, and thus the amount of U-235 and graphite is infinite in each set of cases; only the relative amount of graphite to uranium changes. This allows the effect of adding graphite to the UO₂ fuel's burn-up time to be seen. A reactor assumes a finite system, unlike TRITON. For a given fuel rod diameter, if five percent graphite is added to the UO₂ fuel, there would be a five percent decrease of the U-235 fuel because of the added graphite. A five percent decrease in the U-235 should result in a reduction of burn-up time. For this study, TRITON shows the effect of adding various amounts of graphite to the UO₂ fuel to the burn-up time as purely a function of uranium content.

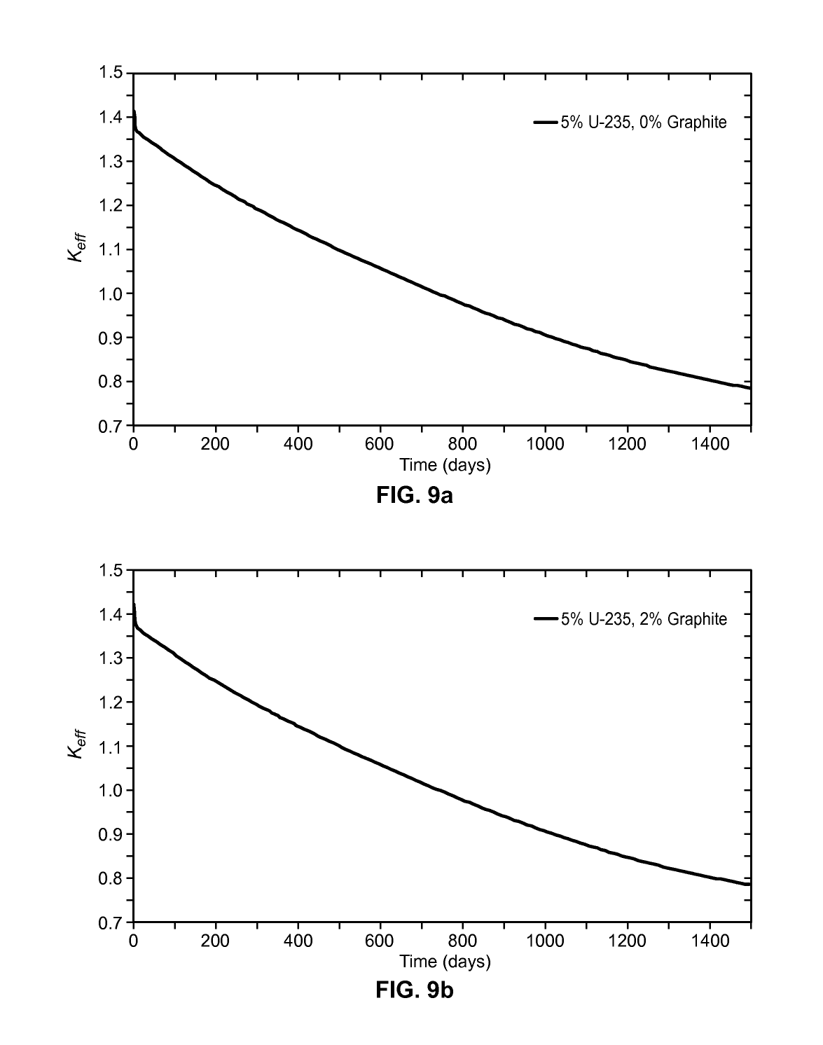

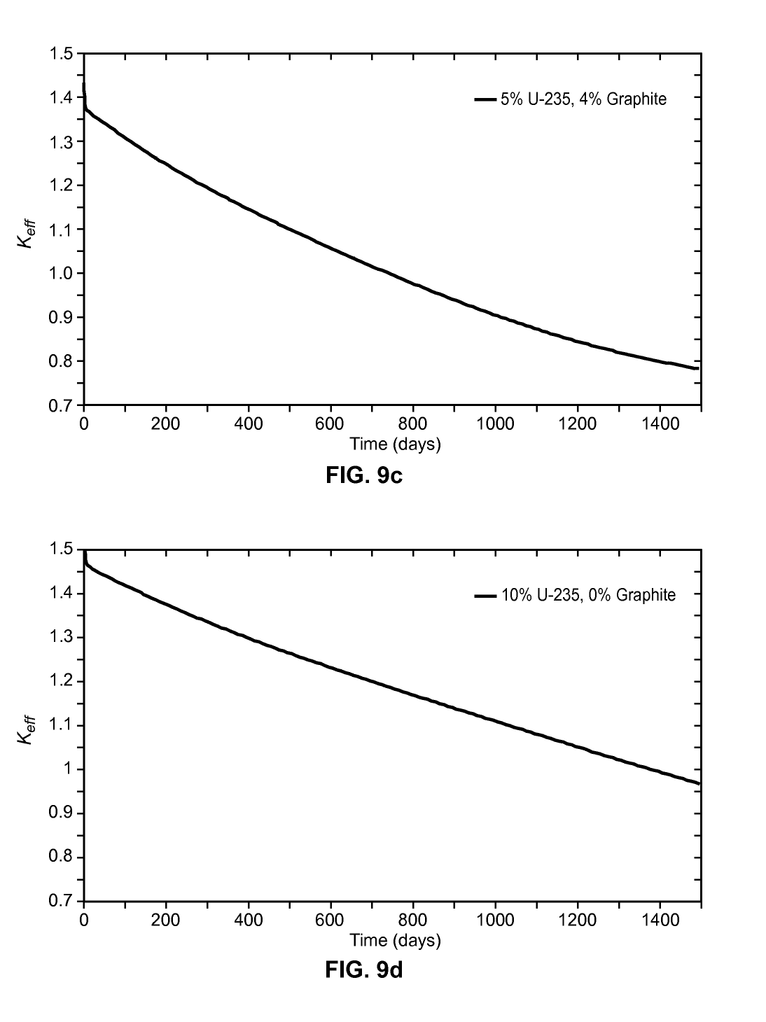

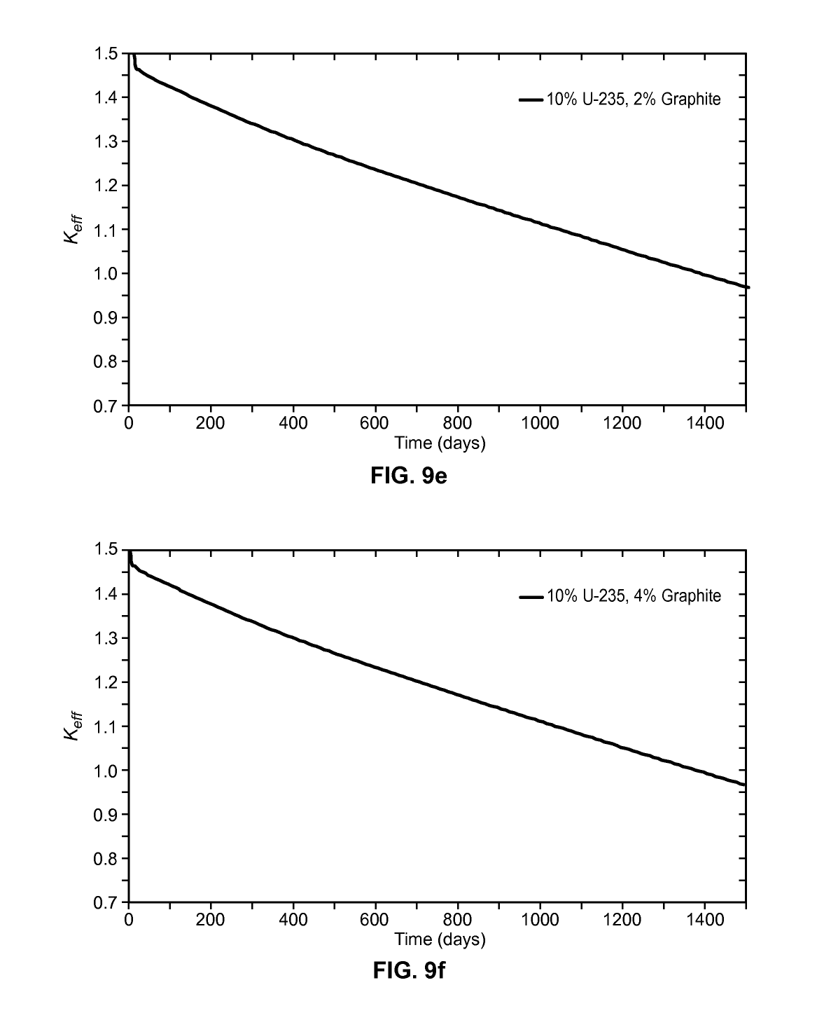

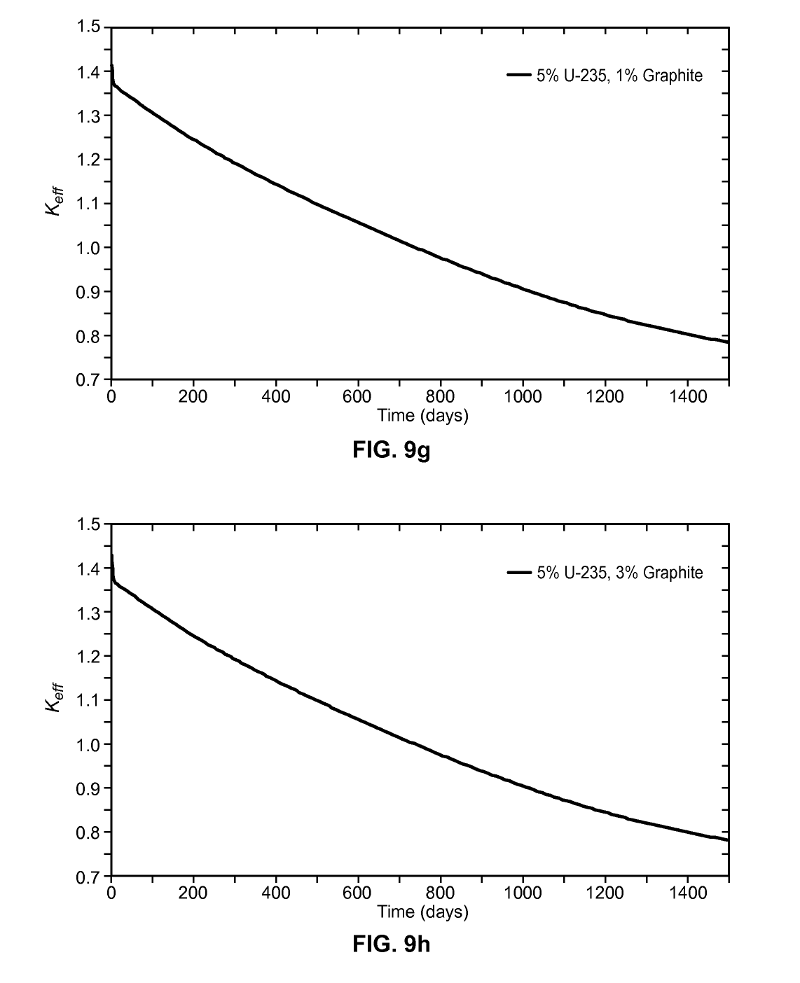

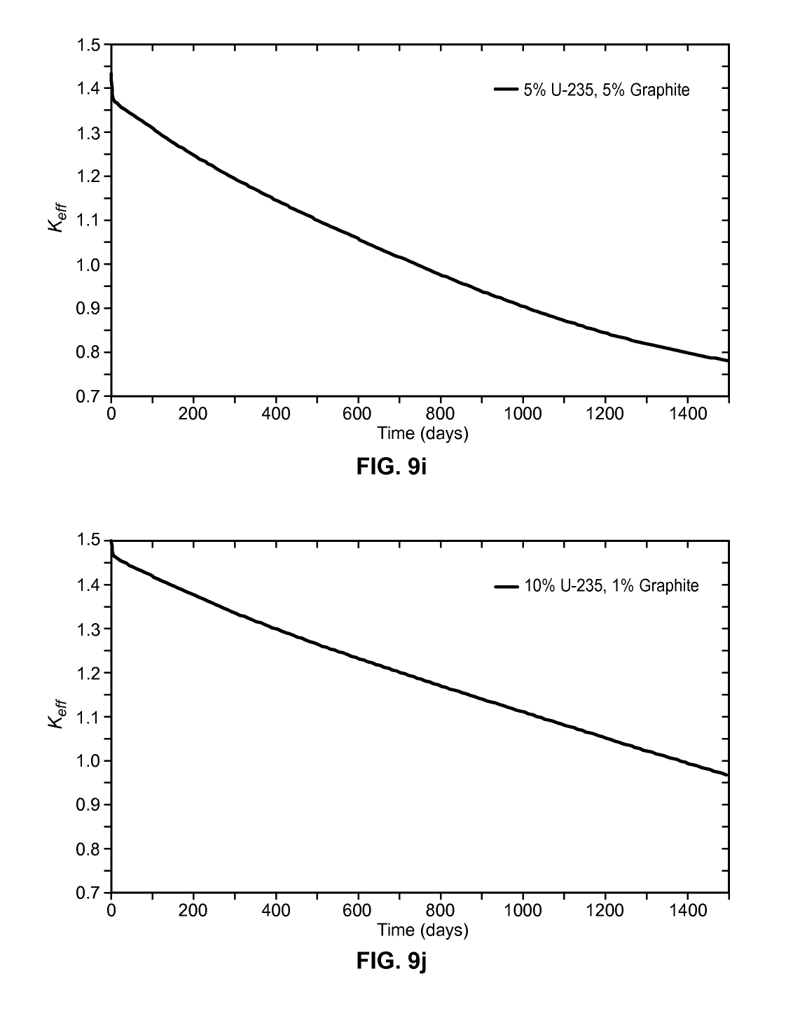

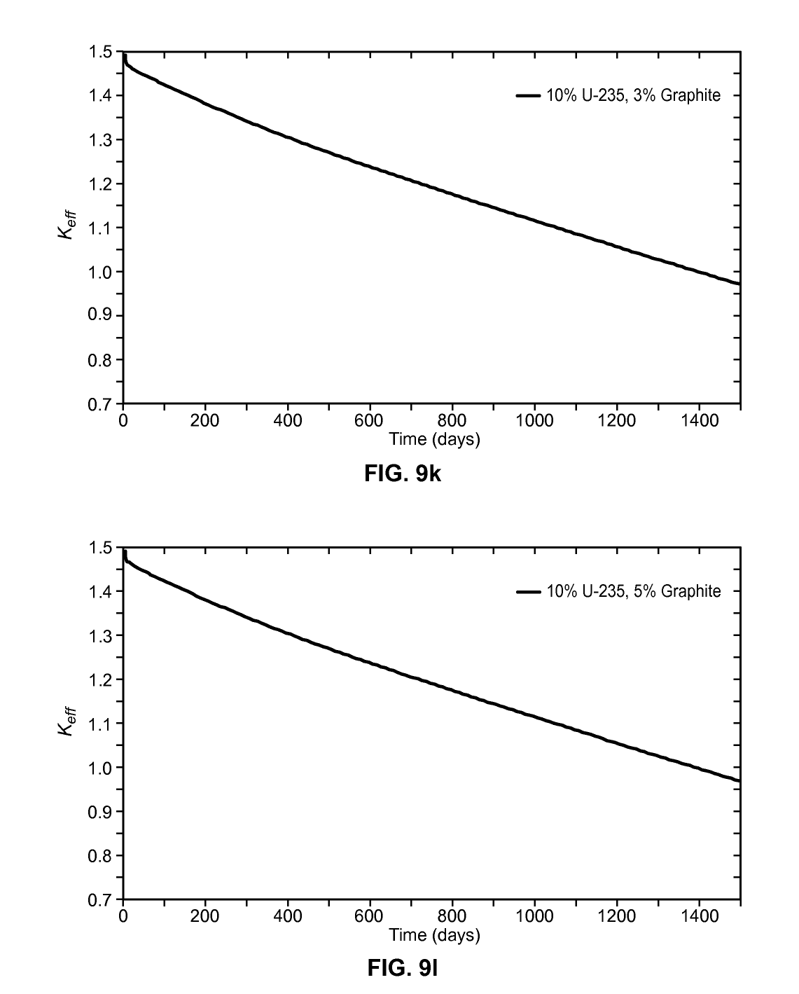

FIGS. 9a-9l show the change in keff as a function of time for the different graphite contents. The five percent uranium-235 UO₂ fuel keff value reaches critical in about 735 days regardless of the graphite content, and then drops below critical after 735 days. For ten percent uranium-235 in the UO₂ fuel, the keff value reaches critical at about 1375 days for zero, one, two, and three percent volume of graphite. The keff value reaches critical at about 1385 days for four and five percent volume of graphite. This is due primarily to the slight softening of the neutron fission spectrum caused by the additional graphite. Doubling the enrichment increases the burn-up time by approximately 87% from 735 to 1375 days. With a greater graphite volume percent, the burn-up time is slightly longer. This is because all reactors are under moderated, and the addition of graphite slightly increases the moderation and reactivity of the fuel. Adding moderator with essentially no additional parasitic neutron absorption directly into the fuel pellet results in a small increase in reactivity, making it possible to burn the fuel a little longer.

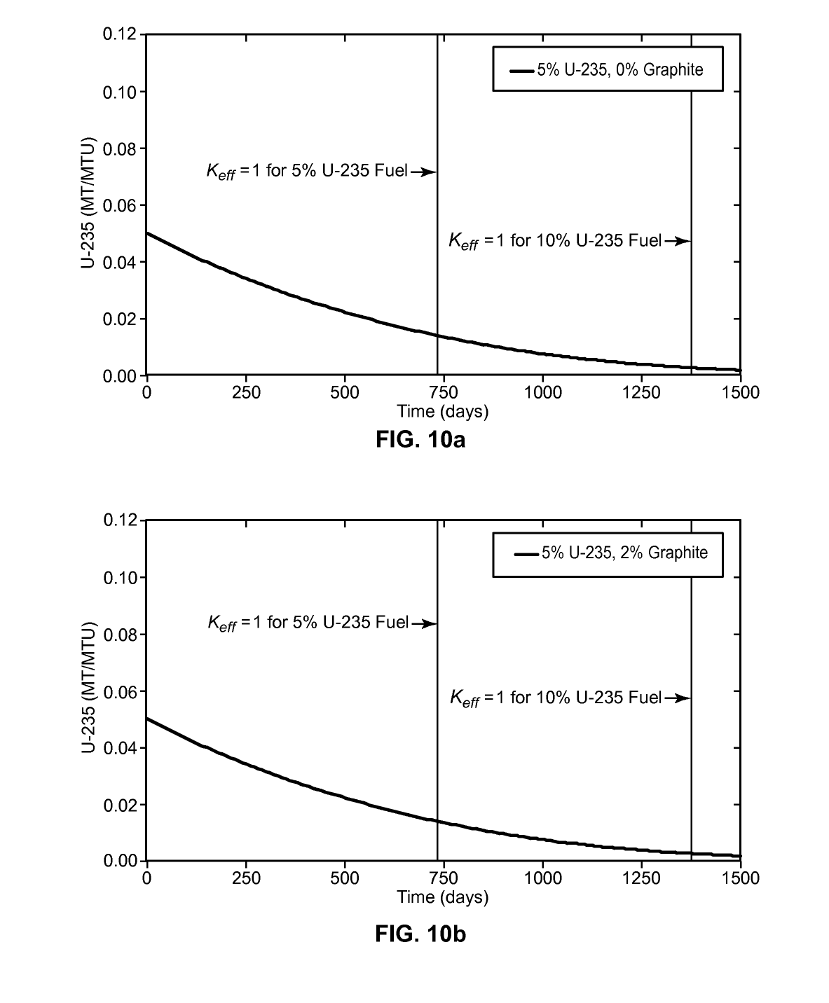

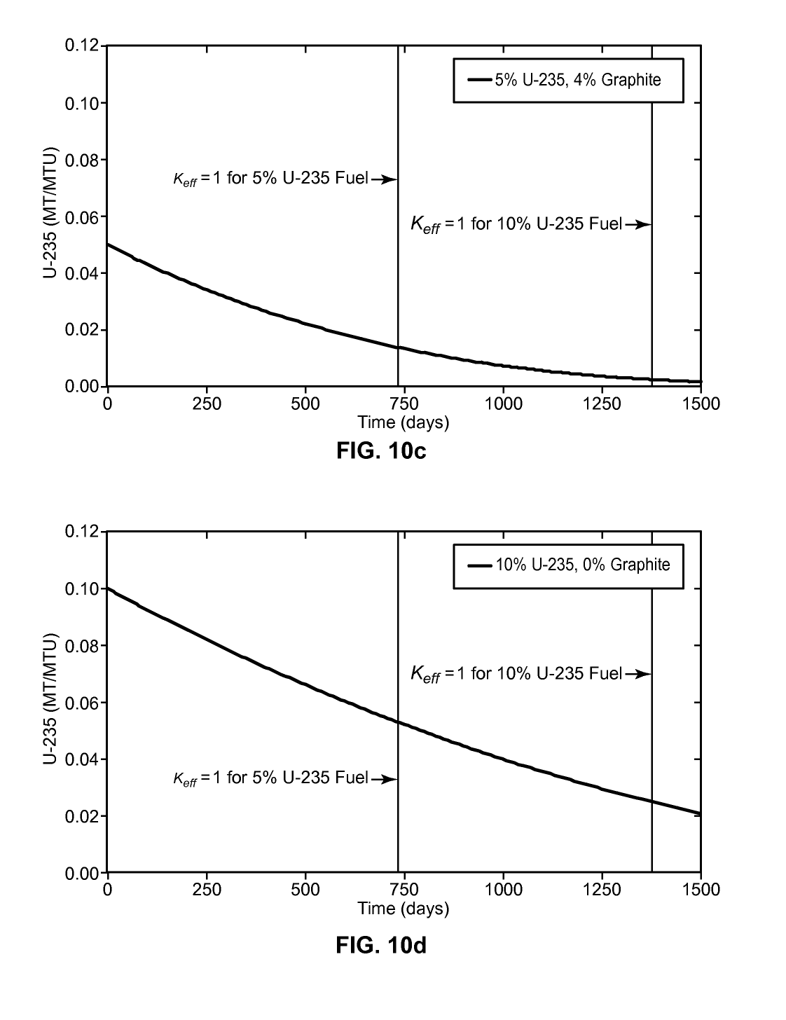

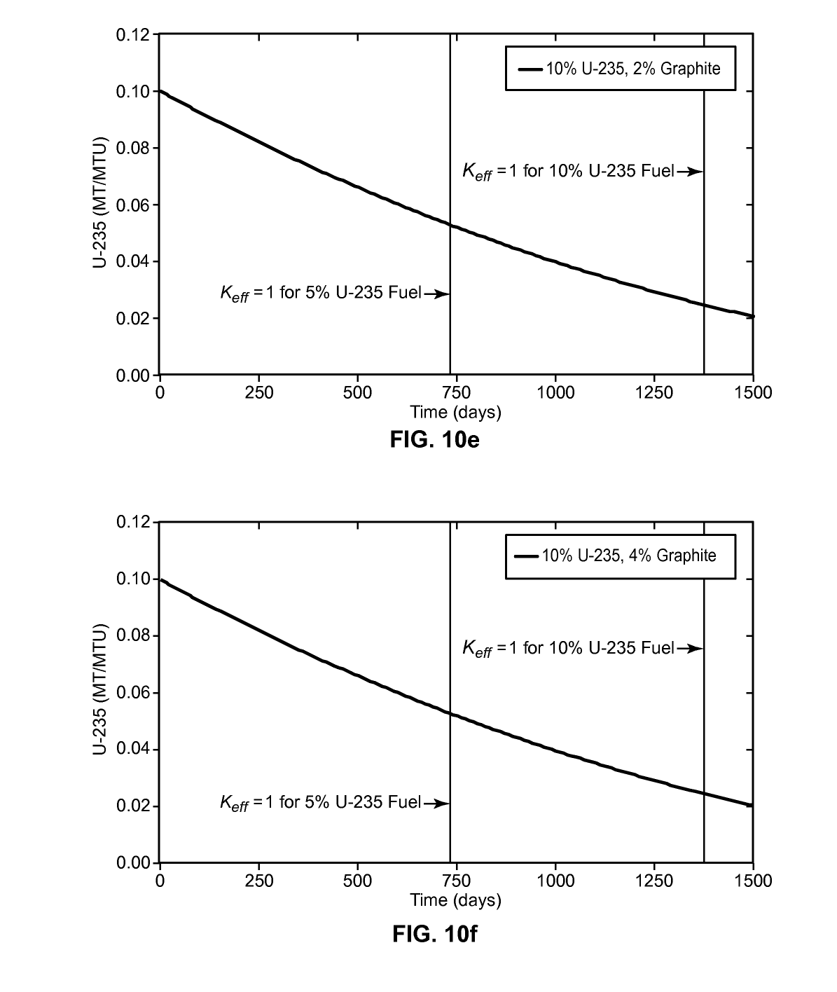

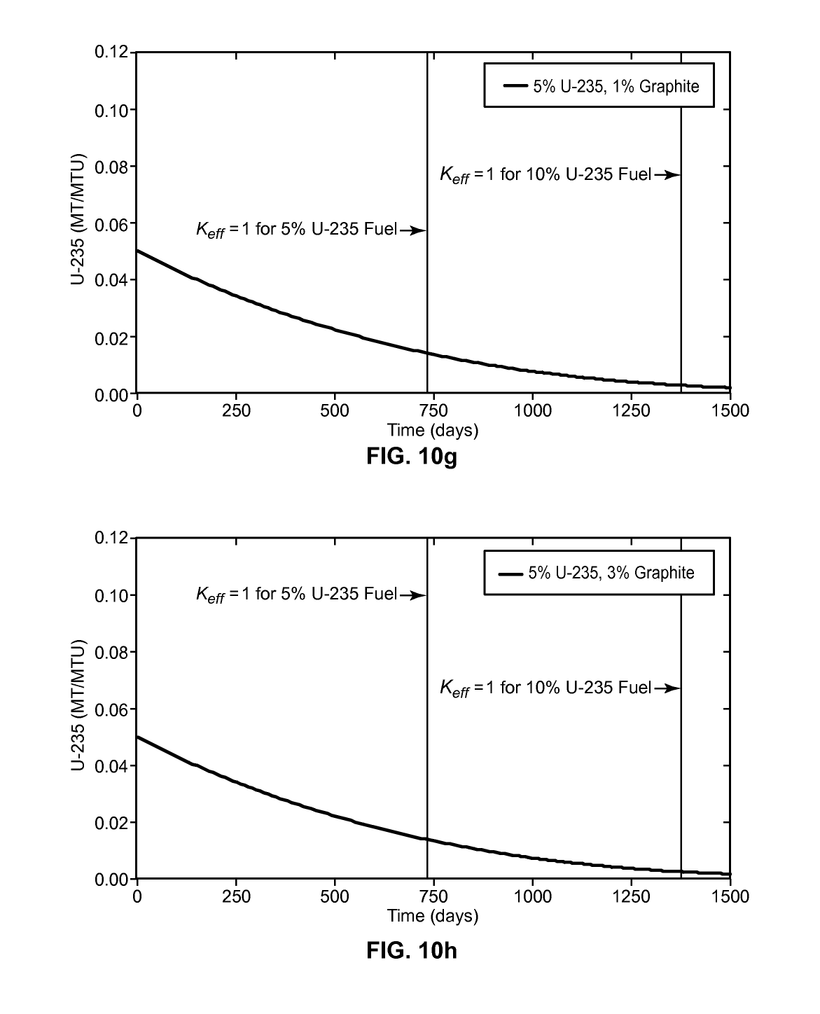

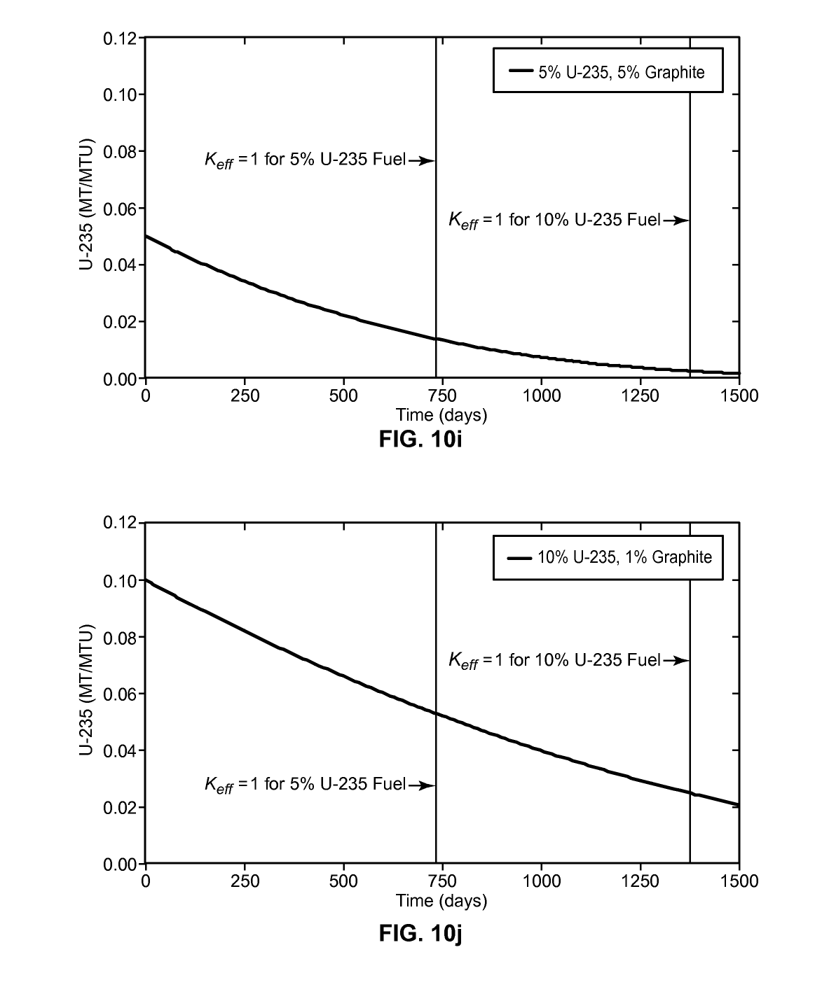

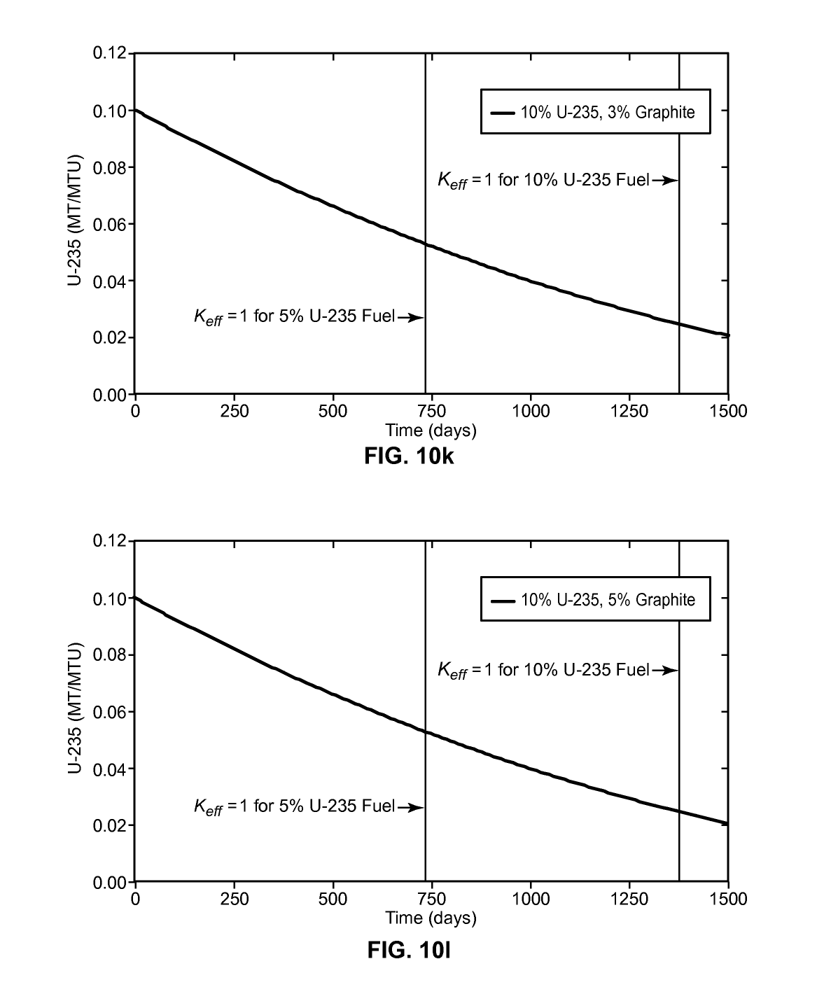

FIGS. 10a-10l show the amount of uranium-235 in terms of metric tones of U-235 per metric ton of uranium during depletion in the 5% and 10% percent uranium-235 UO₂ fuel. The amount of uranium-235 is decreasing as the fuel is being depleted, and the graphite percent does not affect the amount of uranium-235 during depletion.

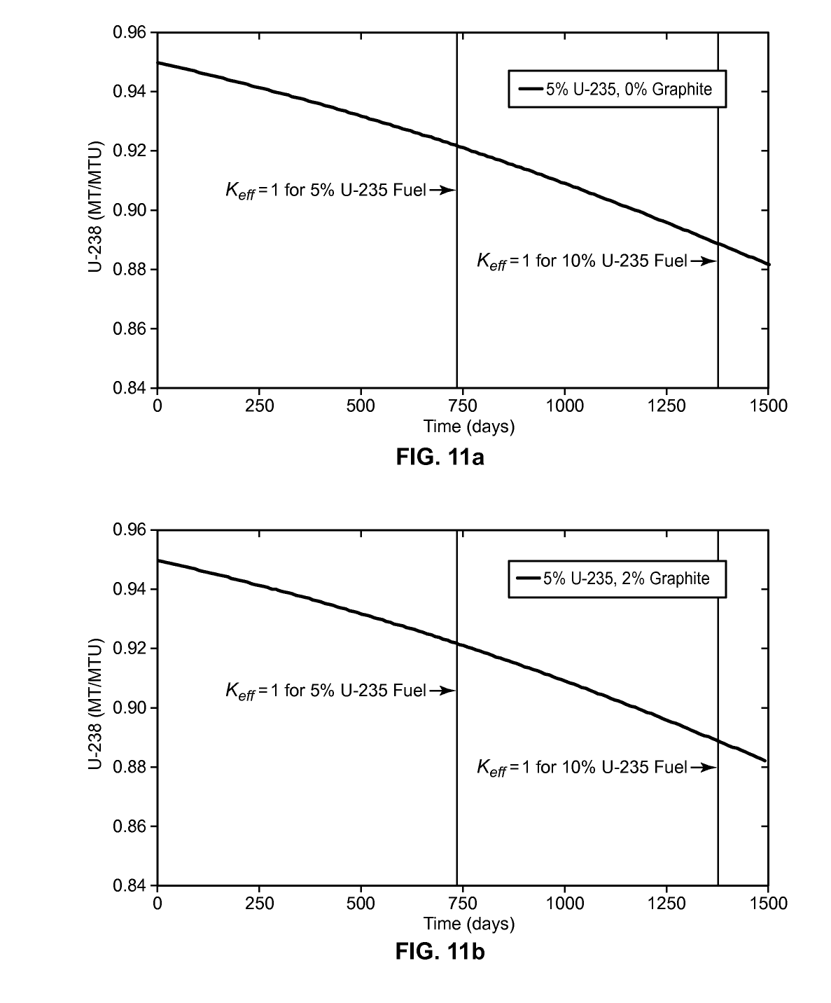

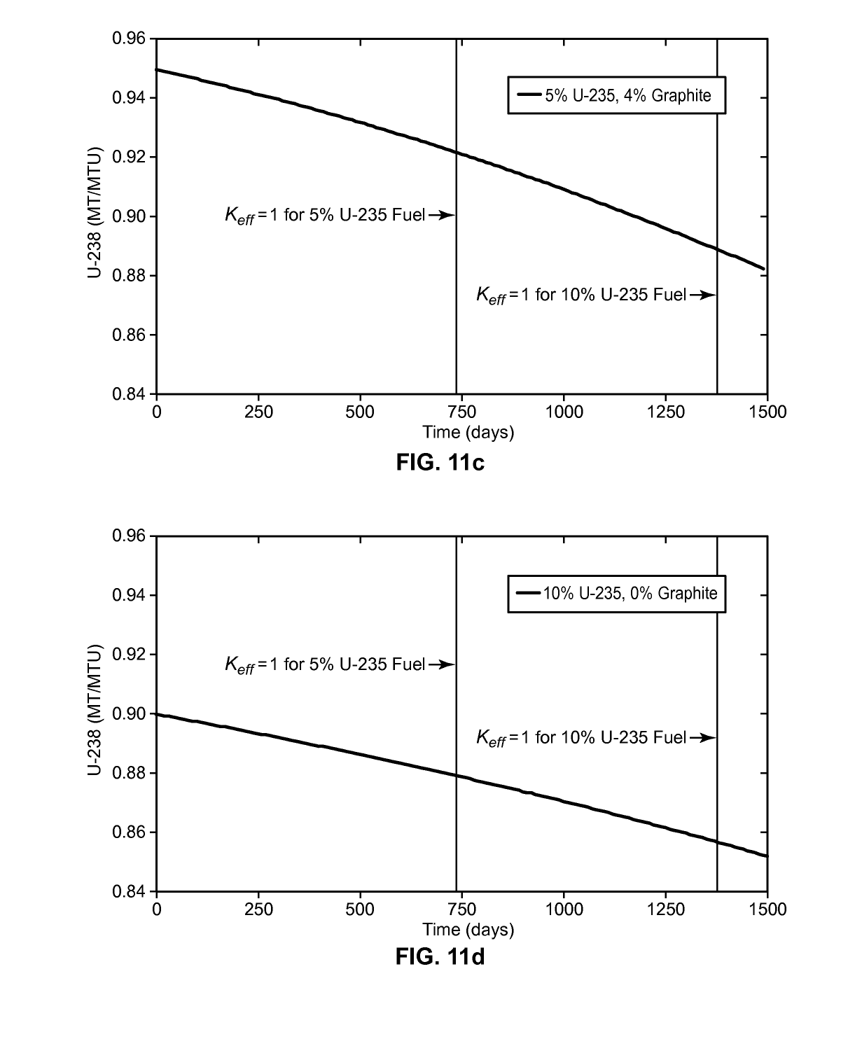

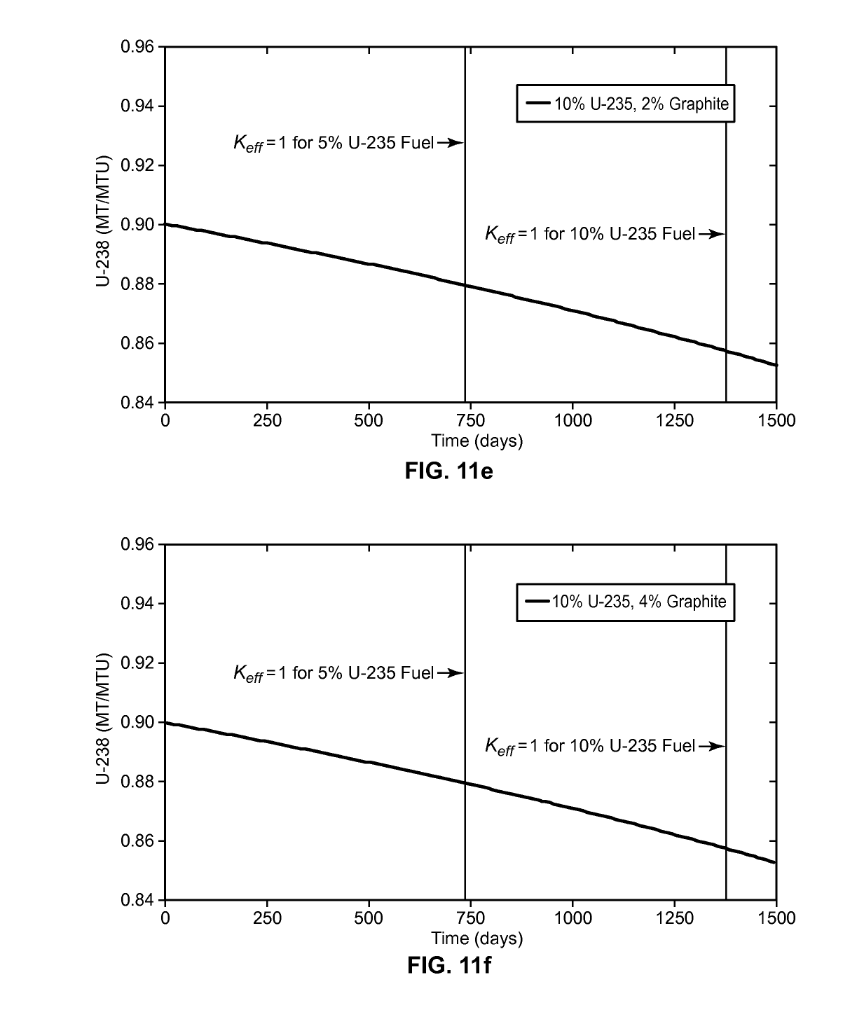

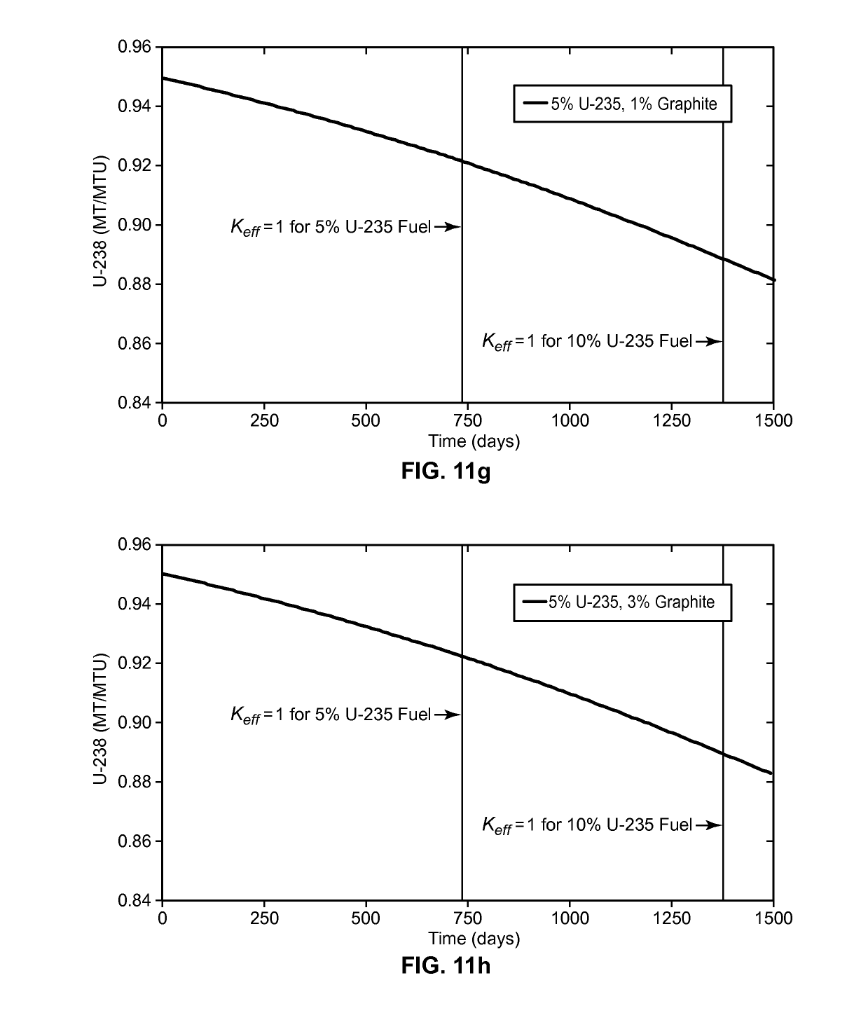

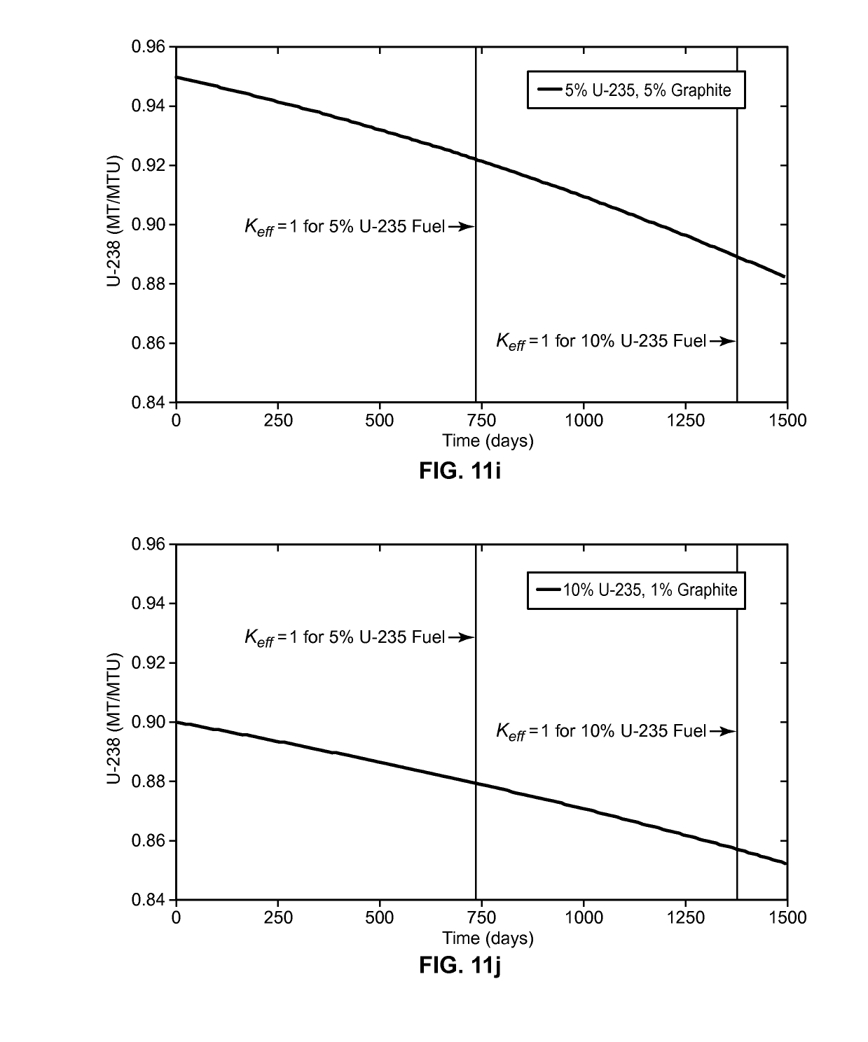

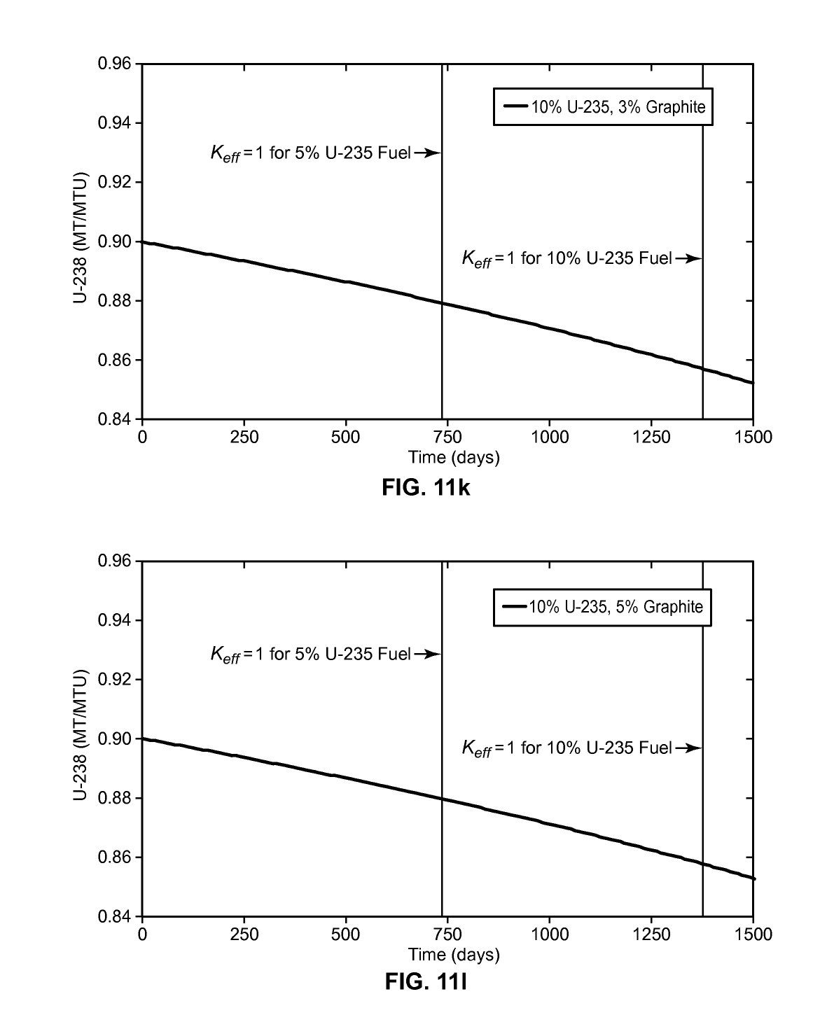

FIGS. 11a-11l show the amount of U-238 in terms of metric tons per metric ton of uranium during the depletion of five and ten percent enriched UO₂ fuel with various graphite volumes. The amount of uranium-238 is decreasing as the fuel depletes. The amount of graphite in the fuel mixtures does not affect the changing amount of U-238 during depletion.

As depletion of the UO₂ fuel is occurring, other fission products and actinides form. The creation of fission products does not change with graphite content. Similarly, actinides such as Pu-239 and Pu-240 are created during the depletion of the UO₂ fuel. In this case, Pu-240 content decreases with increased graphite content. This same decrease exists when the uranium-235 content is increased to 10%.

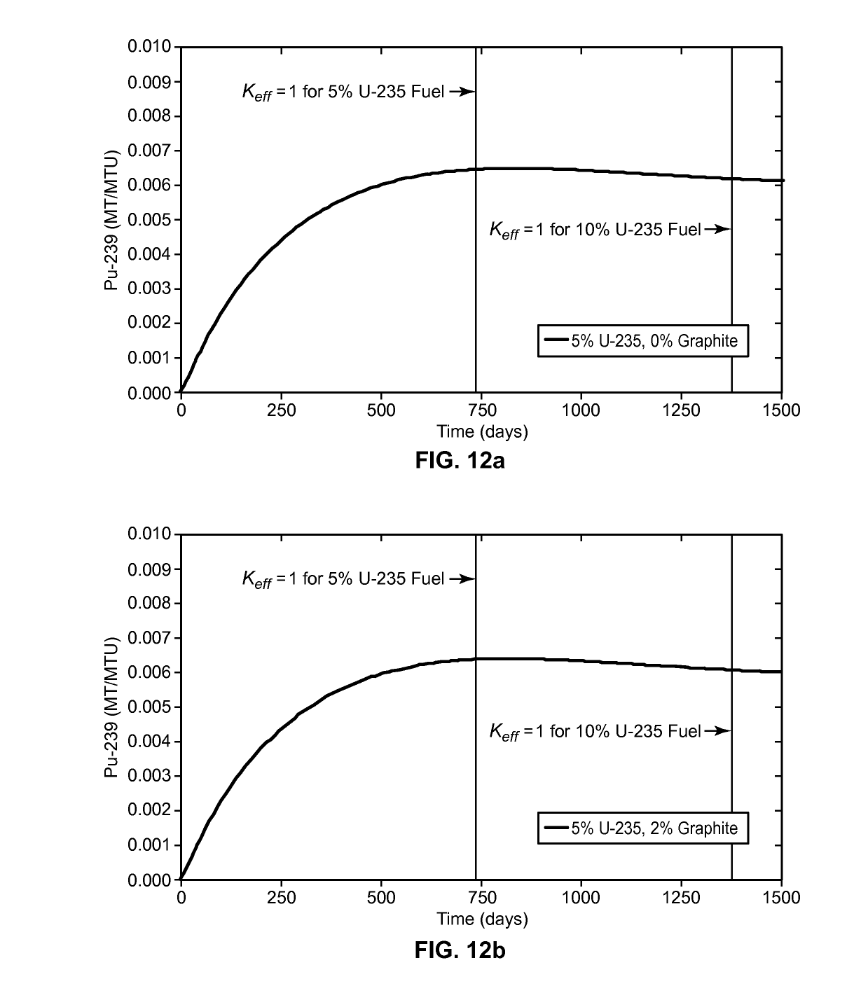

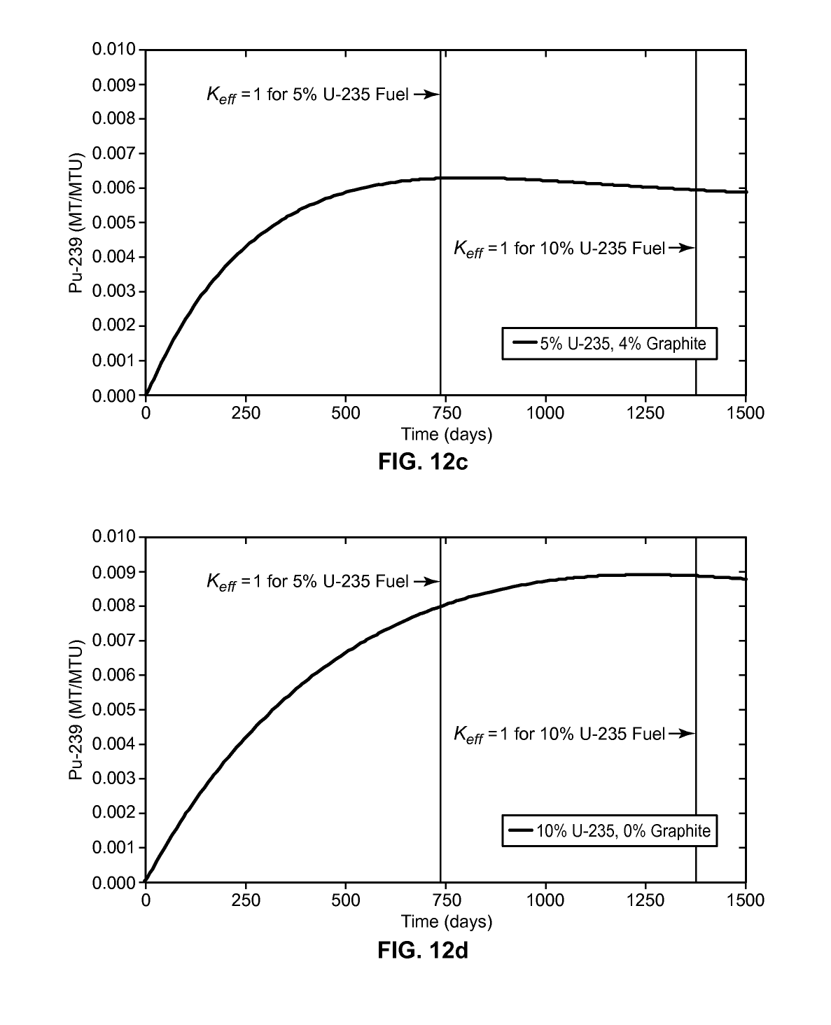

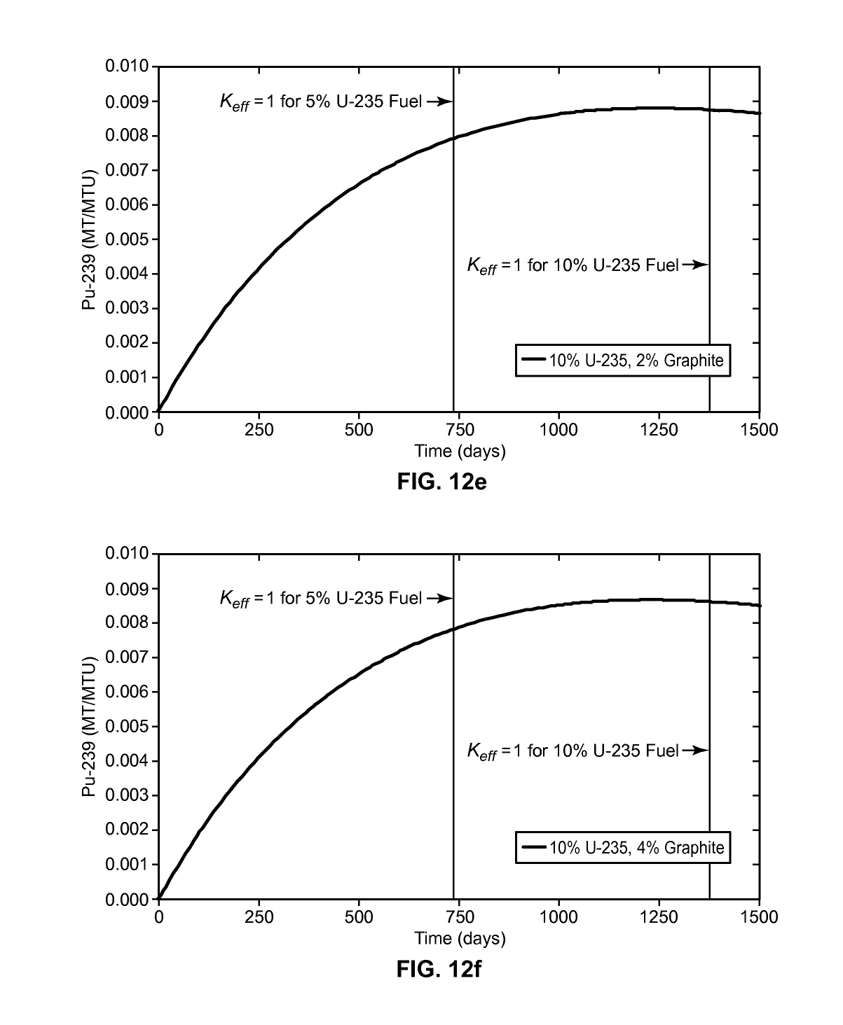

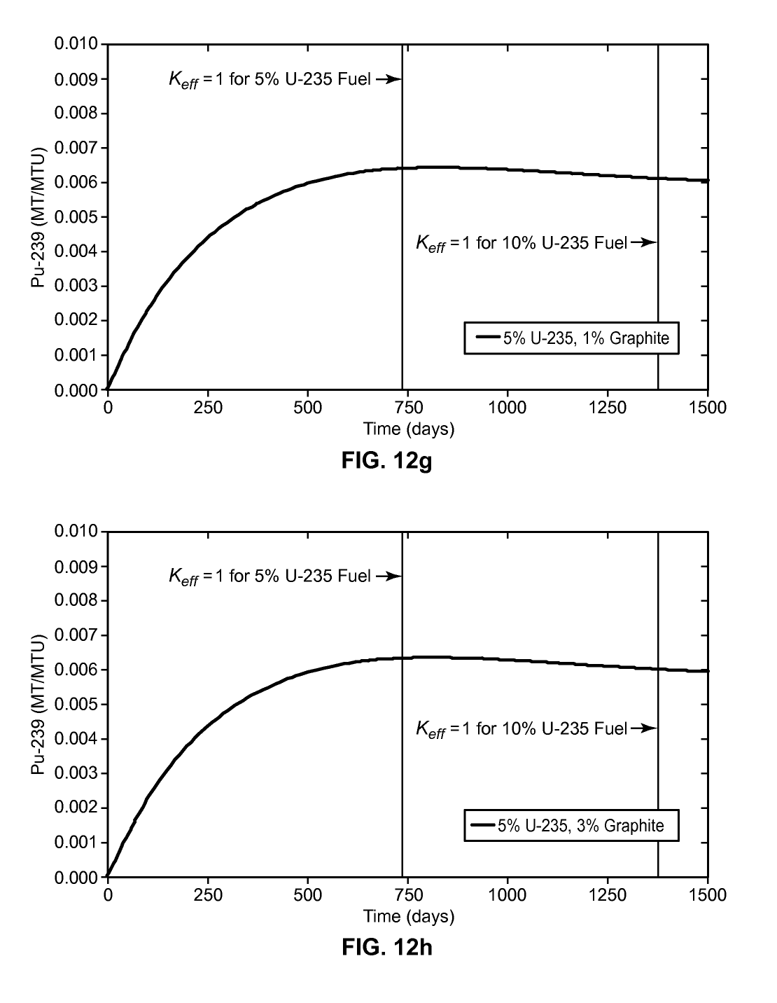

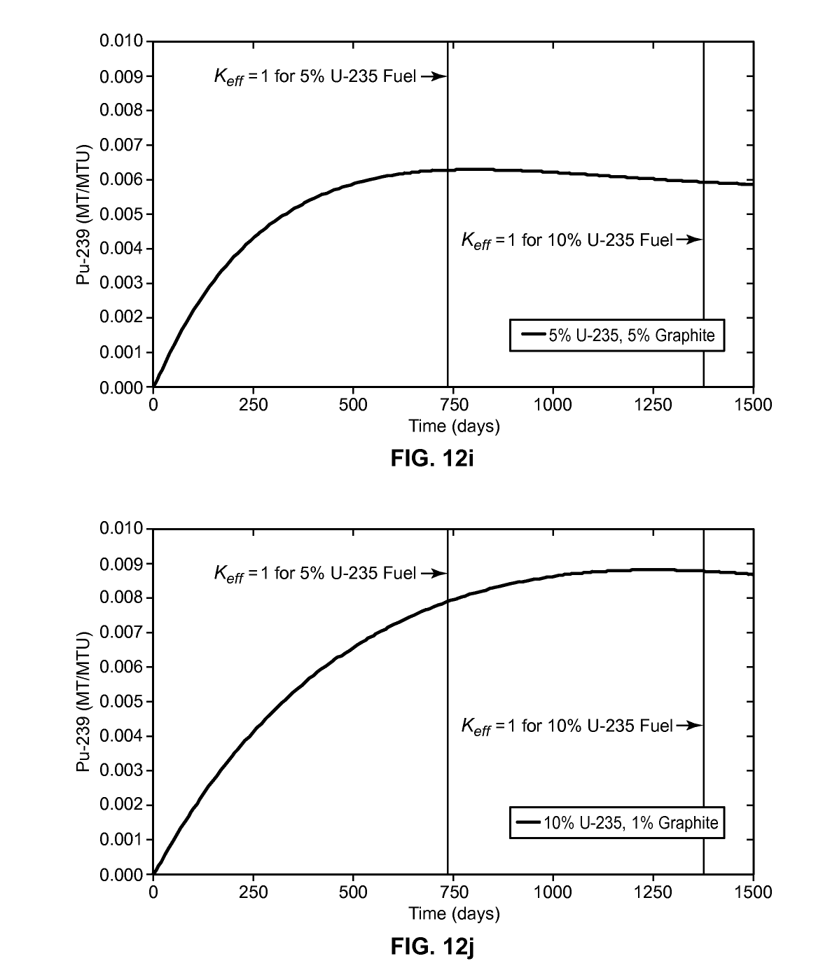

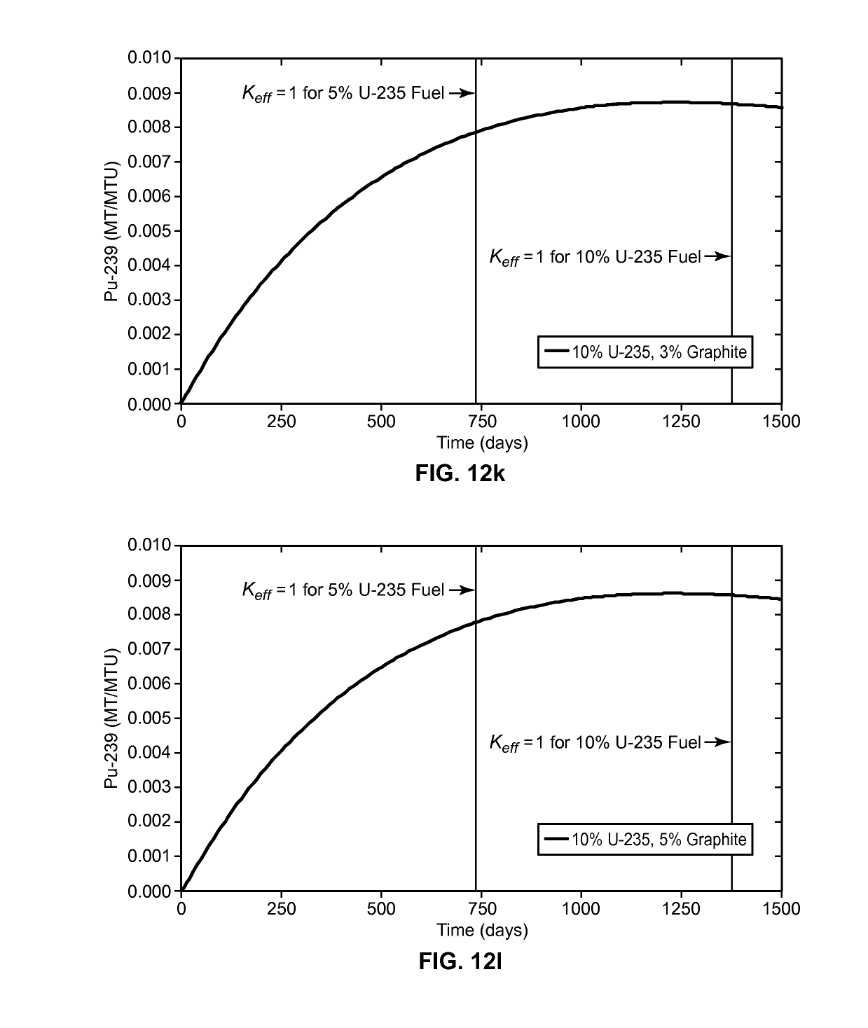

In FIGS. 12a-12l, the amount of plutonium-239 in metric tons Pu-239 per metric ton of uranium during depletion of the five and ten percent enriched fuel is shown. The amount of plutonium-239 increases while both the five and ten percent enriched fuel is being depleted. The amount of graphite in the UO₂ fuel does have a small effect on the amount of plutonium-239 created. Like Pu-240, the amount of Pu-239 created decreases with increasing graphite content. As shown in the figures, the amount of plutonium-239 created reaches a maximum when the reaction reaches critical, which is about 735 days for five percent enriched fuel, and 1375 days for ten percent enriched fuel.

The burn-up, fission production and actinide inventories depend primarily of the amount of uranium-235 in the UO₂/graphite fuel and show little if any dependence on the graphite. This is most likely because graphite has a very low neutron absorption cross-section causing graphite to have a very low parasitic absorption compared to uranium-235.

### Thermal Conductivity of UO₂/Graphite Composite Fuel

The physical analysis of the UO₂/graphite composite fuel focuses on the thermal conductivity of the fuel. To create more energy and less spent fuel, it is advantageous to develop a highly thermally conductive nuclear fuel that allows higher enrichment and longer burn times. The thermal conductivity of the UO₂/graphite fuel may be examined by creating inputs that vary its thermal conductivity. Five versions of the FRAPCON-3 program are created having various fuel thermal conductivities. The original version of the FRAPCON-3 program has the thermal conductivity of current UO₂ fuel; four additional versions of the program are created each sequentially increasing the thermal conductivity by a factor of 2, 3, 4, or 5. The same input is then run for each version of the program. The fuel pellet radial temperature profiles and fractional fission gas release are then compared. FRAPCON-3 is a fuel rod performance code developed by Pacific Northwest National Laboratory. The code evaluates a light water reactor's (LWR's) performance by predicting the UO₂ fuel and cladding temperature at different radii as the fuel burns.

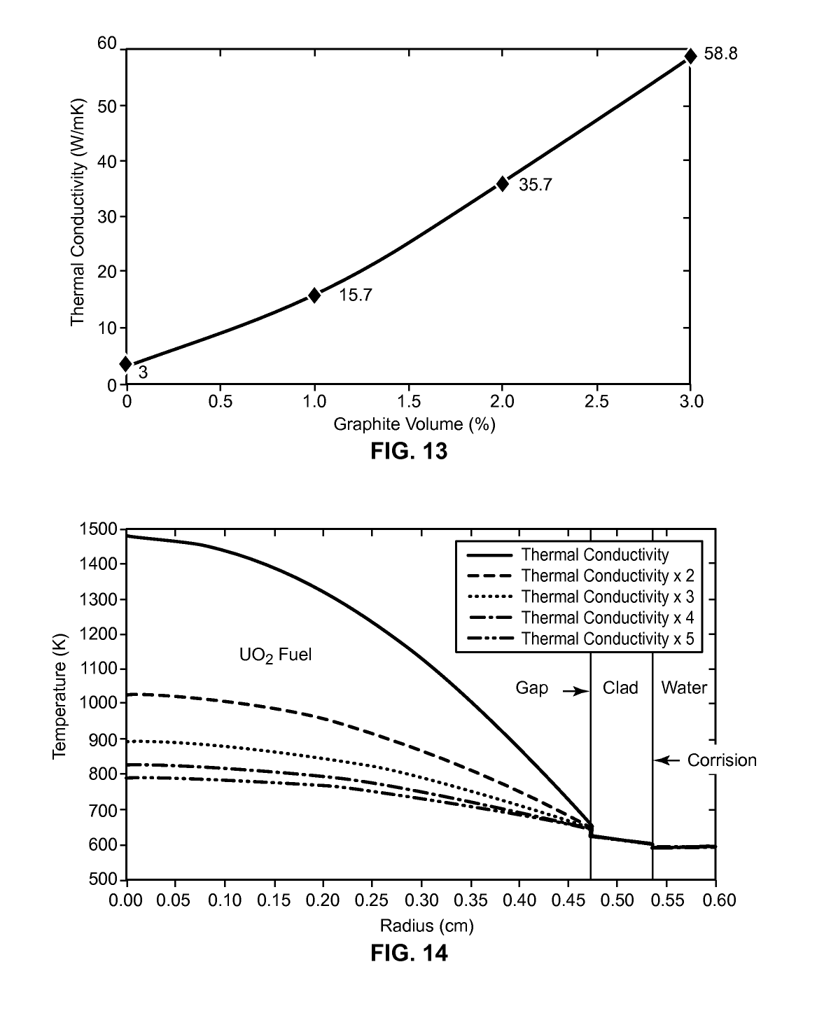

A computer code was developed at Oak Ridge National Laboratory (ORNL) bases on the ANSYS commercial finite element code that is capable of analyzing heterogeneous systems containing materials having different material properties, such as thermal conductivity, in different directions. Computer studies indicate that the addition of graphite (thermal conductivity of ˜2000 W/mK axially and 10 W/mK radially) to UO₂ in a regular array parallel to the desired heat transfer direction will increase the bulk thermal conductivity. FIG. 13 shows how the bulk material thermal conductivity increases with increased fiber volume percent in an idealized system with the fibers perpendicular to the heat transfer surfaces. As shown in FIG. 13, with the addition of one volume percent graphite to the UO₂ fuel, the thermal conductivity of the fuel increases by a factor of about five; a two volume percent addition of increases the bulk thermal conductivity of the material by almost a factor of 12. The addition of three volume percent increases the thermal conductivity by almost a factor of 30. Given this large increase, it is believed that the addition of two volume percent graphite to UO₂ fuel should, at a minimum, double its overall bulk thermal conductivity.

Using modified versions of FRAPCON-3 with an input simulating commercial fuel rods it is possible to simulate the effects of varying the thermal conductivity of the fuel pellets. The original version of the FRAPCON-3 program has the thermal conductivity of current UO₂ fuel. Four additional versions of the program are created, each sequentially increasing the thermal conductivity by a factor of 2, 3, 4, and 5. The same input is employed for the five different versions of the computer program FRAPCON-3, which models the physical characteristics of the UO₂/graphite fuel in the reactor. The only difference between the versions of the program is the thermal conductivity in the UO₂/graphite fuel. Once these programs have run, the temperature at different radii of the UO₂/graphite fuel, cladding and oxide, and the fission gas cumulative fraction release value for each thermal conductivity multiple, are generated.

Knowing the temperatures at different radii are important, because the temperature difference between the centerline of the fuel and the outer edge of the fuel is an indicator of the thermal stresses on the fuel, where a lower temperature difference indicates lower thermal stresses. Lower thermal stress on the fuel may result in less damage to the fuel during use. Also, a lower overall pellet temperature may reduce the stresses and internal pressures caused by the buildup of fission gases as the fuel burns. Thus, a lower overall temperature may result in significantly less fission gas release from the fuel pellets.

After each version of the program is run with the same input; the outputs are analyzed to determine which power-time step has the largest peak linear heat rating. It is found that power-time step 196 has the highest temperature and power for each of the input programs and axial node five for this time-step has the highest temperature and power for all the inputs. This power/time-step and axial node are used to determine the temperature of the fuel pellet at different radii, including the fuel centerline and the fuel edge, the inner cladding and outer cladding, and the oxide.

The temperatures at different radii are then recorded for each modified version of the program, which cover varying thermal conductivities for the UO₂ fuel. These values are plotted on a single graph, shown in FIG. 14. The temperature difference between the fuel centerline and the fuel edge can be seen in this figure. The peak centerline temperature dramatically drops as the thermal conductivity of the fuel is increased.

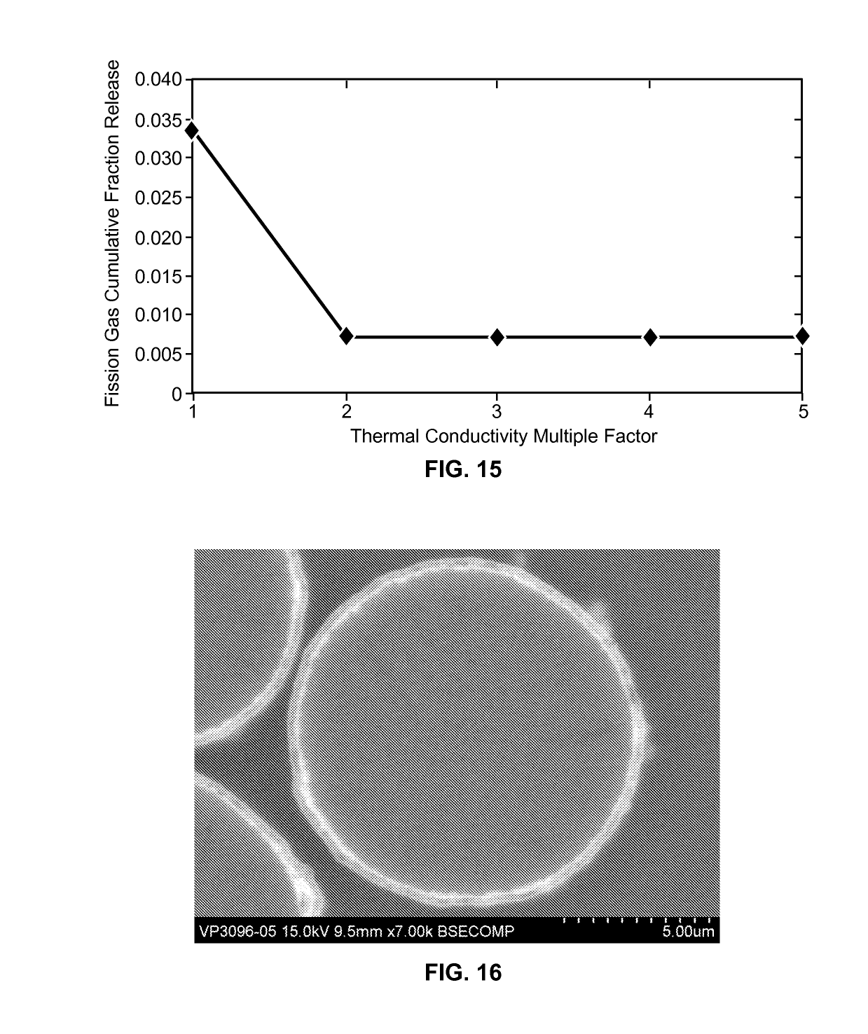

FIG. 15 shows the fission gas cumulative fraction release for the different thermal conductivities of the fuel. When the thermal conductivity of the UO₂/graphite fuel is increased, the fission gas cumulative fraction release is decreased. This is caused by the lower temperature difference between the fuel centerline and the fuel edge and the lower overall fuel pellet temperature. The decreased temperature and temperature differential reduce the internal radioactive fission gases pressures, which in turn limit the amount of radioactive fission gases being released from the fuel pellets. The fission gas cumulative fraction release greatly decreases for thermal conductivity multiple factors above 2. FRAPCON-3 is unable to calculate fission gas release values at the resultant lower fuel temperatures, so the curves are flat at reduced temperatures. In reality, the fission gas cumulative fraction release is expected to be significantly lower than indicated by the program.

The UO₂ fuel with long thin fibers of graphite heterogeneously mixed throughout has the neutronic, burn-up, and physical characteristics to be beneficial for use in a nuclear reactor. For a given graphite volume percent, homogeneously mixed graphite is neutronically similar or equivalent to heterogeneous graphite fiber over a range of fiber diameters and graphite volume percents. Therefore, homogeneously mixed graphite fuel and heterogeneous mixed graphite fuel may provide substantially the same neutronic properties. During depletion of the fuel, graphite has a slight positive effect on the burn-up time of the fuel because it is a moderator. The low parasitic absorption in the fuel means the graphite does not compete with uranium for neutrons to any significant extent and thus does not substantially affect the burn-up time of the fuel. When doubling the thermal conductivity of the UO₂/graphite fuel, the temperature difference between the fuel centerline and the fuel edge is almost halved. Therefore, increasing the thermal conductivity of the UO₂/graphite fuel may decrease the thermal stresses of the fuel, allowing for a more stable fuel with less radiation induced damage and less fission gas release.

An increase in the thermal conductivity of the UO₂ fuel opens the door to the ability to increase the power density of the world fleet of operating nuclear power reactors. The increased thermal conductivity should allow the power density to be increased by over 10% while increasing the safety margin of the fuel. Instead of the thermal conductivity of UO₂ being the limiting condition, existing nuclear power plant output would be limited by the balance of plant: i.e., water flow rate, heat transfer and flow rates of the steam generator, etc. Thus, future reactors could be redesigned to take advantage of the higher fuel thermal conductivity and produce significantly higher power densities than current reactors using the new UO₂/graphite fuel.

Although the present invention has been described in considerable detail with reference to certain embodiments thereof, other embodiments are possible without departing from the present invention.

The spirit and scope of the appended claims should not be limited, therefore, to the description of the preferred embodiments contained herein. All embodiments that come within the meaning of the claims, either literally or by equivalence, are intended to be embraced therein. Furthermore, the advantages described above are not necessarily the only advantages of the invention, and it is not necessarily expected that all of the described advantages will be achieved with every embodiment.

1. A composite nuclear fuel pellet, the composite fuel pellet comprising:
a composite body comprising a UO₂ matrix and a plurality of high aspect ratio particles dispersed therein, the high aspect ratio particles having a thermal conductivity higher than that of the UO₂ matrix.

2. The composite nuclear fuel pellet of claim 1, wherein the high aspect ratio particles comprise carbon.

3. The composite nuclear fuel pellet of claim 2, wherein the carbon comprises highly ordered graphite.

4. The composite nuclear fuel pellet of claim 2, wherein the high aspect ratio particles comprise at least one of carbon fibers, carbon foam, and carbon nanotubes.

5. The composite nuclear fuel pellet of claim 1, wherein the high aspect ratio particles comprise a non-carbon material.

6. The nuclear fuel pellet of claim 1, wherein the high aspect ratio particles have a neutron absorption cross-section lower than that of the UO₂ matrix by at least two orders of magnitude.

7. The nuclear fuel pellet of claim 1, wherein the composite body includes about 5 vol. % or less of the high aspect ratio particles.

8. The nuclear fuel pellet of claim 7, wherein the composite body includes from about 1 vol. % to about 3 vol. % of the high aspect ratio particles.

9. The nuclear fuel pellet of claim 1, wherein the high aspect ratio particles have a length-to-width ratio ranging from about 100 to about 500.

10. The nuclear fuel pellet of claim 1, wherein the high aspect ratio particles comprise a length ranging from about 50% to about 100% of a radius of the composite body, the composite body having a generally cylindrical shape.

11. The nuclear fuel pellet of claim 10, wherein the length of the high aspect ratio particles ranges from about 0.25 cm to about 1.25 cm.

12. The nuclear fuel pellet of claim 1, wherein the high aspect ratio particles comprise a width ranging from about 5 microns to 15 microns.

13. The nuclear fuel pellet of claim 12, wherein the width is a diameter of the particles.

14. The nuclear fuel pellet of claim 1, wherein the high aspect ratio particles comprise a barrier layer.

15. The nuclear fuel pellet of claim 14, wherein the barrier layer comprises a carbide.

16. The nuclear fuel pellet of claim 15, wherein the carbide is one of SiC or B₄C.

17. The nuclear fuel pellet of claim 1, wherein the high aspect ratio particles are randomly oriented in the composite body.

18. The nuclear fuel pellet of claim 1, wherein at least a portion of the high aspect ratio particles are aligned substantially parallel to a base of the composite body, the composite body having a generally cylindrical shape.

19. The nuclear fuel pellet of claim 1, wherein the composite body comprises a thermal conductivity of at least twice that of an unreinforced UO₂ fuel pellet.

20. The nuclear fuel pellet of claim 1, wherein the composite body has a cylindrical shape including a diameter of between about 0.5 cm and about 1.25 cm and a thickness of between about 3 mm and about 12 mm.

21. A method of making a nuclear fuel pellet, the method comprising:
combining UO₂ powder with a predetermined amount of high aspect ratio particles to form a combined powder, the high aspect ratio particles having a thermal conductivity higher than that of the UO₂ powder;
mixing the combined powder in a solvent to disperse the high aspect ratio particles in the UO₂ powder;
evaporating the solvent to form a dry mixture comprising the high aspect ratio particles dispersed in the UO₂ powder;
pressing the dry mixture to form a green body; and
sintering the green body to form the composite fuel pellet.

22. The method of claim 21, further comprising, prior to combining the UO₂ powder with the high aspect ratio particles, forming a barrier layer comprising a carbide on a surface of the high aspect ratio particles.

23. The method of claim 21, wherein the mixing is carried out in a container having a base and a centerline perpendicular to the base, and further comprising orienting at least a portion of the high aspect ratio particles in the UO₂ powder substantially parallel to the base of the container.

24. The method of claim 23, wherein substantially all of the high aspect ratio particles are oriented substantially parallel to the base of the container.

25. The method of claim 21, wherein the mixing is carried out for a time duration sufficient to obtain a homogeneous dispersion of high aspect ratio particles in the UO₂ powder

26. The method of claim 25, wherein the time duration is between about 0.5 h and about 24 h.

27. The method of claim 21, wherein the solvent is an aqueous solvent.

28. The method of claim 21, wherein the solvent is an organic solvent.

29. The method of claim 21, wherein the solvent includes a dispersant at a concentration of at least about 1% by weight.

30. The method of claim 29, wherein the dispersant is selected from the group consisting of polyvinylpyrrolidone, amines, polyethylene glycol, phenols, polyesters, polyvinyl butyral resin, oxazoline compounds, ethoxylated alkylguanidine amine complexes, myristate, palmitate, and glyceryl mono/dioleate.

31. The method of claim 29, wherein the dispersant is selected from the group consisting of latex/acrylic, acrylic acid, polyacrylic acid, polyacrylate, methylacrylate, polyethyleneimine (PEI), polyethylene oxide (PEO), PEO/PEI comb polymers, polyvinyl alcohol, polysaccharides, alginates, xanthan gum, guar gum, carrageenan, gum arabic, gellan gum, cellulose, methycellulose, polyvinylpyrrolidone, phosphates, stearic acids, stearates, sulfonic acids, sulfonates, polyesters, sulfosuccinic acid and its derivatives, sulfonic acids, and phosphate esters.

32. The method of claim 21, wherein the high aspect ratio particles comprise carbon.
